(19) United States
(12) Patent Application Publication
(10) Pub. No.: US 2019/0359761 A1
(43) Pub. Date: Nov. 28, 2019

(54) METHOD FOR LOWERING EMISSIONS OF A POLYURETHANE FOAM

(71) Applicant: COVESTRO DEUTSCHLAND AG, Leverkusen (DE)

(72) Inventors: Rolf ALBACH, Köln (DE); Petra VENNER, Leverkusen (DE); Stefan LINDNER, Remscheid (DE)

(21) Appl. No.: 16/469,891

(22) PCT Filed: Dec. 18, 2017
(86) PCT No.: PCT/EP2017/083346

§ 371 Date: Jun. 14, 2019

(30) Foreign Application Priority Data
Dec. 19, 2016 (EP) 16204942.3

(51) Int. Cl. C08G 18/76; C08J 9/12; C08G 18/48; C08G 18/38; C08G 18/32; C08G 18/66

(52) U.S. Cl. CPC C08G 18/7671; C08J 9/125; C08G 18/4833; C08G 18/3819; C08G 2101/005; C08G 18/3206; C08G 18/3825; C08G 18/3834; C08G 18/6666; C08G 18/3838

(57) ABSTRACT

The present invention relates to a process for producing polyurethanes, preferably polyurethane foams, by reaction of compounds containing isocyanate-reactive hydrogen atoms with di- and/or polyisocyanates in the presence of one or more compounds selected from the group consisting of:

NC—CHR¹—CONR¹²—X (I),

NC—CHR²—CONR³-aryl (II),

NC—CHR⁴—CO₂H (III),

[NC—CHR⁵—CO₂]ₘY^{m+} (IV),
wherein
   X represents NR⁶R⁷, OR⁸, CONR⁹R¹⁰ or COOR¹¹,
   R¹ to R¹² each independently of one another represent H, an optionally substituted C₁-C₈ alkyl group or an optionally substituted aryl group,
   Y represents a monovalent or divalent cation and
   m represents 1 or 2.

The present invention further relates to the polyurethanes obtainable from this process, and to the use of such polyurethanes, for example in the interior of automobiles.

It is known from the prior art about polyurethane foams can emit aldehydes, these aldehyde emissions generally being unwanted. These emissions are detected for example in measurements according to VDA 275 (flask method, 3 h 60° C.) or else according to VDA 276 (emissions chamber test, 65° C.).

Both EP2138520 and WO2015082316 describe that certain cyanoacetamides can be suitable for reducing the emissions of formaldehyde from foams. Furthermore, WO2015082316 describes that certain esters of cyanoacetic acid and of 3-oxocarboxylic acids can be suitable therefor.

Hydrazides such as acethydrazide have likewise been described as suitable additives for reducing formaldehydes (EP 1674515). Polyhydrazodicarbonamides, obtainable from the reaction of hydrazine with isocyanates, are also suitable for this purpose. However, these have the disadvantage that they are in the form of particles and rigidify foams. This is not desired for flexible foams. The same problem appears when using polyurea dispersions which are likewise suitable for reducing the formaldehyde emissions from foams.

The present invention has for its object to provide polyurethanes, preferably polyurethane foams, exhibiting even lower formaldehyde emission than polyurethanes/polyurethane foams of the prior art. This object was achieved with the following process:

The present invention provides a process for producing polyurethanes, preferably polyurethane foams, by reaction of compounds containing isocyanate-reactive hydrogen atoms with di- and/or polyisocyanates in the presence of one or more compounds selected from the group consisting of:

NC—CHR¹—CONR¹²—X (I),

NC—CHR²—CONR³-aryl (II),

NC—CHR⁴—CO₂H (III),

[NC—CHR⁵—CO₂]ₘY^{m+} (IV),
wherein
   X represents NR⁶R⁷, OR, CONR⁹R¹⁰ or COOR¹¹,
   R¹ to R¹² each independently of one another represent H, an optionally substituted C₁-C₈ alkyl group or an optionally substituted aryl group,
   Y represents a monovalent or divalent cation and
   m represents 1 or 2.

The present invention also provides the polyurethanes/polyurethane foams obtainable by the described process.

The present invention in particular provides a process for producing polyurethanes, preferably polyurethane foams, which comprises reacting with one another
A1 compounds containing isocyanate-reactive hydrogen atoms having an OH number according to DIN 53240 of ≥15 to <260 mg KOH/g,
A2 optionally compounds containing isocyanate-reactive hydrogen atoms having an OH number according to DIN 53240 of ≥260 to <4000 mg KOH/g,
A3 water and/or physical blowing agents,
A4 optionally auxiliary and additive substances such as
   a) catalysts,
   b) surface-active additive substances,
   c) pigments and/or flame retardants,
A5 one or more compounds selected from the group consisting of:

NC—CHR¹—CONR¹²—X (I),

NC—CHR²—CONR³-aryl (II),

NC—CHR⁴—CO₂H (III),

[NC—CHR⁵—CO₂]ₘY^{m+} (IV),
wherein
   X represents NR⁶R⁷, OR⁸, CONR⁹R¹⁰ or COOR¹¹,
   R¹ to R¹² each independently of one another represent H, an optionally substituted C₁-C₈ alkyl group or an optionally substituted aryl group,
   Y represents a monovalent or divalent cation and
   m represents 1 or 2,
and
B di- and/or polyisocyanates.

The usage amount of the inventive component A5 based on 1 kg of the components A1 and B is 1 to 100 g, preferably 5 to 50 g (the value of 1 kg relates to the sum of A1 and B).

Very particular preference (alternative I) is given to a process for producing polyurethanes, preferably polyurethane foams, which comprises reacting with one another
A1 75 to 99.0 parts by weight (based on the sum of the parts by weight of components A1 to A4) of compounds containing isocyanate-reactive hydrogen atoms having an OH number according to DIN 53240 of ≥15 to <260 mg KOH/g,
A2 0 to 10 parts by weight (based on the sum of the parts by weight of components A1 to A4) of compounds containing isocyanate-reactive hydrogen atoms having an OH number according to DIN 53240 of ≥260 to <4000 mg KOH/g,
A3 0.5 to 24.5 parts by weight (based on the sum of the parts by weight of components A1 to A4) of water and/or physical blowing agents,
A4 0.5 to 10 parts by weight (based on the sum of the parts by weight of components A1 to A4) of auxiliary and additive substances such as
   a) catalysts,
   b) surface-active additive substances,
   c) pigments and/or flame retardants,
A5 1 to 100 g per kg of the components A1 and B, preferably 5 to 50 g per kg of the components A1 and B (sum of A1 and B), of one or more compounds selected from the group consisting of:

NC—CHR¹—CONR¹²—X (I),

NC—CHR²—CONR³-aryl (II),

NC—CHR⁴—CO₂H (III),

[NC—CHR⁵—CO₂]ₘY^{m+} (IV),
wherein
   X represents NR⁶R⁷, OR⁸, CONR⁹R¹⁰ or COOR¹¹,
   R¹ to R¹² each independently of one another represent H, an optionally substituted C₁-C₈ alkyl group or an optionally substituted aryl group,
   Y represents a monovalent or divalent cation and
   m represents 1 or 2,
and
B di- or polyisocyanates,
wherein all reported parts by weight for the components A1 to A4 are normalized such that the sum of the parts by weight of the components A1+A2+A3+A4 in the composition adds up to 100.

Likewise very particularly preferred (alternative II) is a process for producing polyurethanes, preferably polyurethane foams, which comprises reacting with one another
A1 25 to 45 parts by weight (based on the sum of the parts by weight of components A1 to A4) of compounds containing isocyanate-reactive hydrogen atoms having an OH number according to DIN 53240 of ≥15 to <260 mg KOH/g,
A2 20 to 74 parts by weight (based on the sum of the parts by weight of components A1 to A4) of compounds containing isocyanate-reactive hydrogen atoms having an OH number according to DIN 53240 of ≥260 to <4000 mg KOH/g,
A3 0.5 to 25 parts by weight (based on the sum of the parts by weight of components A1 to A4) of water and/or physical blowing agents,
A4 0.5 to 10 parts by weight (based on the sum of the parts by weight of components A1 to A4) of auxiliary and additive substances such as
   d) catalysts,
   e) surface-active additives,
   f) pigments and/or flame retardants,
A5 1 to 100 g per kg of the components A1 and B, preferably 5 to 50 g per kg of the components A1 and B (sum of A1 and B), of one or more compounds selected from the group consisting of:

NC—CHR¹—CONR¹²—X (I),

NC—CHR²—CONR³-aryl (II),

NC—CHR⁴—CO₂H (III),

[NC—CHR⁵—CO₂]ₘY^{m+} (IV),
wherein
   X represents NR⁶R⁷, OR⁸, CONR⁹R¹⁰ or COOR¹¹,
   R¹ to R¹² each independently of one another represent H, an optionally substituted C₁-C₈ alkyl group or an optionally substituted aryl group,
   Y represents a monovalent or divalent cation and
   m represents 1 or 2,
and
B di- or polyisocyanates,
wherein all reported parts by weight for the components A1 to A4 are normalized such that the sum of the parts by weight of the components A1+A2+A3+A4 in the composition adds up to 100.

It has been found that compounds of formulae (I) to (IV) (component A5) are surprisingly more effective as aldehyde scavengers than the hitherto known compounds. The invention therefore further provides for the use of one or more compounds of formulae (I) bis (IV) in polyurethane compositions or in processes for producing polyurethanes, preferably polyurethane foams, for reducing the formaldehyde emission of the polyurethanes/polyurethane foams resulting therefrom.

The production of isocyanate-based foams is known per se and described for example in DE-A 1 694 142, DE-A 1 694 215 and DE-A 1 720 768 and also in Kunststoff-Handbuch volume VII, Polyurethanes, edited by Vieweg and Höchtlein, Carl Hanser Verlag, Munich 1966, and in the new edition of this book, edited by G. Oertel, Carl Hanser Verlag Munich, Vienna 1993.

The production of the isocyanate-based foams may employ the components more particularly described hereinbelow.

### Component A1

Starting components of the component A1 are compounds having at least two isocyanate-reactive hydrogen atoms having an OH number according to DIN 53240 of ≥15 to <260 mg KOH/g, preferably ≥20 to ≤150 mg KOH/g, particularly preferably ≥20 to ≤50 mg KOH/g, very particularly preferably ≥25 to ≤40 mg KOH/g. These include for example polyethers and polyesters and also polycarbonates and polyesteramides containing at least 2, generally 2 to 8, but preferably 2 to 6, hydroxyl groups such as are known per se for the production of homogeneous and of cellular polyurethanes and such as are described for example in EP-A 0 007 502, pages 8-15. Polyethers and polyesters containing at least two hydroxyl groups are preferred according to the invention. Polyethers containing at least two hydroxyl groups are particularly preferred.

The production of the polyether polyols is carried out by known methods, preferably by base-catalyzed polyaddition of alkylene oxides onto polyfunctional starter compounds containing active hydrogen atoms, for example alcohols or amines. Examples include: ethylene glycol, diethylene glycol, 1,2-propylene glycol, 1,4-butanediol, hexamethylene glycol, bisphenol A, trimethylolpropane, glycerol, pentaerythritol, sorbitol, sucrose, degraded starch, water, methylamine, ethylamine, propylamine, butylamine, aniline, benzylamine, o- and p-toluidine, α,β-naphthylamine, ammonia, ethylenediamine, propylenediamine, 1,4-butylenediamine, 1,2-, 1,3-, 1,4-, 1,5- and/or 1,6-hexamethylenediamine, o-, m-, and p-phenylenediamine, 2,4-, 2,6-tolylenediamine, 2,2′-, 2,4- and 4,4′-diaminodiphenylmethane and diethylenediamine.

Preferably employed as alkylene oxides are ethylene oxide, propylene oxide, butylene oxide and mixtures thereof. The construction of the polyether chains by alkoxylation may be performed with only one monomeric epoxide or else in random or blockwise fashion with two or three different monomeric epoxides.

Processes for producing such polyether polyols are described in “Kunststoffhandbuch, volume 7, Polyurethane”, in “Reaction Polymers” and for example in U.S. Pat. Nos. 1,922,451, 2,674,619, 1,922,459, 3,190,927 and 3,346,557.

The polyaddition may also be carried out with DMC catalysis for example. DMC catalysts and the use thereof for producing polyether polyols are described for example in U.S. Pat. Nos. 3,404,109, 3,829,505, 3,941,849, 5,158,922, 5,470,813, EP-A 700 949, EP-A 743 093, EP-A 761 708, WO-A 97/40086, WO-A 98/16310 and WO-A 00/47649.

In a particularly preferred embodiment component A1 contains at least 30% by weight of at least one polyoxyalkylene polymer consisting of a starter, propylene oxide and optionally ethylene oxide and optionally an end block made of ethylene oxide, wherein the total weight of the end blocks is on average 3-20% by weight, preferably 5-15% by weight and particularly preferably 6-10% by weight based on the total weight of all polyoxyalkylene polymers.

In addition to the described “simple” polyether polyols the process according to the invention may also employ polyether carbonate polyols. Polyether carbonate polyols are obtainable for example by catalytic reaction of ethylene oxide and propylene oxide, optionally further alkylene oxides and carbon dioxide in the presence of H-functional starter substances (see for example EP-A 2046861). Methods for producing polyester polyols are likewise well known and described for example in the two abovementioned citations (“Kunststoffhandbuch, volume 7, Polyurethane”, “Reaction Polymers”). The polyester polyols are produced inter alia by polycondensation of polyfunctional carboxylic acids or derivatives thereof, for example acid chlorides or anhydrides, with polyfunctional hydroxyl compounds.

Employable polyfunctional carboxylic acids include for example: adipic acid, phthalic acid, isophthalic acid, terephthalic acid, oxalic acid, succinic acid, glutaric acid, azelaic acid, sebacic acid, fumaric acid or maleic acid.

Employable polyfunctional hydroxyl compounds include for example: Ethylene glycol, diethylene glycol, triethylene glycol, 1,2-propylene glycol, dipropylene glycol, 1,3-butanediol, 1,4-butanediol, 1,6-hexanediol, 1,12-dodecanediol, neopentyl glycol, trimethylolpropane, triethylolpropane or glycerol.

Production of the polyester polyols may moreover also be effected by ring-opening polymerization of lactones (for example caprolactone) with diols and/or triols as starters.

Also employable in component A1 as hydroxyl-containing compounds of the component A1 are polymer polyols, PUD polyols and PIPA polyols. Polymer polyols are polyols containing proportions of solid polymers produced by free-radical polymerization of suitable monomers such as styrene or acrylonitrile in a base polyol. PUD (polyureadispersion) polyols are produced for example by in-situ polymerization of an isocyanate or an isocyanate mixture with a diamine and/or hydrazine in a polyol, preferably a polyether polyol. The PUD dispersion is preferably produced by reaction of an isocyanate mixture of 75% to 85% by weight of 2,4-tolylene diisocyanate (2,4-TDI) and 15 to 25% by weight of 2,6-tolylene diisocyanate (2,6-TDI) with a diamine and/or hydrazine in a polyether polyol, preferably a polyether polyol, produced by alkoxylation of a trifunctional starter (for example glycerol and/or trimethylolpropane). Processes for producing PUD dispersions are described for example in U.S. Pat. Nos. 4,089,835 and 4,260,530. PIPA polyols are polyether polyols modified with alkanolamines by polyisocyanate-polyaddition, wherein the polyether polyol has a functionality of 2.5 to 4 and a hydroxyl number of ≥3 mg KOH/g to ≤112 mg KOH/g (number-average molecular weight 500 to 18 000). PIPA polyols are described in detail in GB 2 072 204 A, DE 31 03 757 A1 and U.S. Pat. No. 4,374,209 A.

### Component A2

Optionally employed as component A2 are compounds having at least two isocyanate-reactive hydrogen atoms and an OH number according to DIN 53240 of ≥260 to <4000 mg KOH/g, preferably ≥400 to ≤3000 mg KOH/g, particularly preferably ≥1000 to ≤2000 mg KOH/g.

These include compounds having hydroxyl groups and optionally amino groups, thiol groups or carboxyl groups, preferably compounds containing hydroxyl groups and optionally amino groups. These compounds have preferably 2 to 8, particularly preferably 2 to 4, isocyanate-reactive hydrogen atoms.

These may be for example low molecular weight diols (for example 1,2-ethanediol, 1,3- or 1,2-propanediol, 1,4-butanediol), triols (for example glycerol, trimethylolpropane), tetraols (for example pentaerythritol), hexaols (for example sorbitol) or amino alcohols (ethanolamine, diethanolamine, triethanolamine).

However, they may also be short chain polyether polyols, polyether carbonate polyols, polyester polyols, polyester carbonate polyols, polythioether polyols, polyacrylate polyols or polycarbonate polyols.

For production of these polymers (reactants, processes) reference is made to what is stated above in connection with A1.

Further examples of compounds of component A2 are described in EP-A 0 007 502, pages 16-17.

### Component A3

Employed as component A3 are water and/or physical blowing agents. Employed as physical blowing agents are, for example, carbon dioxide and/or volatile organic substances as blowing agents.

### Component A4

Employed as component A4 are auxiliary and additive substances such as
a) catalysts (activators),
b) surface-active added substances (surfactants), such as emulsifiers and foam stabilizers, in particular those with low emission such as for example products of the Tegostab® LF series,
c) additives such as reaction retardants (for example acidic substances such as hydrochloric acid or organic acid halides), cell regulators (for example paraffins or fatty alcohols or dimethylpolysiloxanes), pigments, dyes, flame retardants (for example tricresyl phosphate), stabilizers against aging and weathering effects, plasticizers, fungistatic and bacteriostatic substances, fillers (for example barium sulfate, kieselguhr, carbon black chalk or precipitated chalk) and release agents.

These auxiliary and additive substances for optional co-use are described for example in EP-A 0 000 389, pages 18-21. Further examples of auxiliary and additive substances for optional co-use according to the invention and also details concerning ways these auxiliary and additive substances are used and function are described in Kunststoff-Handbuch, volume VII, edited by G. Oertel, Carl-Hanser-Verlag, Munich, 3rd edition, 1993, for example on pages 104-127.

Preferred catalysts are aliphatic tertiary amines (for example trimethylamine, tetramethylbutanediamine), cycloaliphatic tertiary amines (for example 1,4-diaza[2.2.2]bicyclooctane), aliphatic amino ethers (for example dimethylaminoethyl ether and N,N,N-trimethyl-N-hydroxyethylbisaminoethyl ether), cycloaliphatic amino ethers (for example N-ethylmorpholine), aliphatic amidines, cycloaliphatic amidines, urea, derivatives of urea (for example aminoalkylureas; see, for example, EP-A 0 176 013), especially (3-dimethylaminopropylamine)urea), and tin catalysts (for example dibutyltin oxide, dibutyltin dilaurate, tin octoate).

Particularly preferred catalysts are a) urea, derivatives of urea and/or b) the abovementioned amines and amino ethers, characterized in that the amines and amino ethers contain a functional group that undergoes chemical reaction with the isocyanate. The functional group is preferably a hydroxyl group or a primary or secondary amino group. These particularly preferred catalysts have the advantage that they exhibit strongly reduced migration and emission characteristics. Examples of particularly preferred catalysts include: (3-dimethylaminopropylamine)urea, 1,1′-((3-(dimethylamino)propyl)imino)bis-2-propanol, N-[2-[2-(dimethylamino)ethoxy]ethyl]-N-methyl-1,3-propanediamine and 3-dimethylaminopropylamine.

### Component A5

Component A5 comprises compounds selected from the group consisting of:

NC—CHR¹—CONR¹²—X (I),

NC—CHR²—CONR³-aryl (II),

NC—CHR⁴—CO₂H (III),

[NC—CHR⁵—CO₂]ₘY^{m+} (IV),
wherein
   X represents NR⁶R⁷, OR⁸, CONR⁹R¹⁰ or COOR¹¹,
   R¹ to R¹² each independently of one another represent H, an optionally substituted C₁-C₈ alkyl group or an optionally substituted aryl group,
   Y represents a monovalent or divalent cation and
   m represents 1 or 2.

In a preferred variant the radicals R1 to R12 each independently of one another represent H or a C₁-C₆ alkyl group. In a particularly preferred variant the radicals R1, R2, R4 and R5 independently of one another represent H and the radicals R3 and R6 to R12 independently of one another represent H or a C₁-C₆ alkyl group.

Of the compounds (I) bis (IV), the compounds (I) and (II) are preferred for use in the process according to the invention.

### Component B

Employed as component B are aliphatic, cycloaliphatic, araliphatic, aromatic and heterocyclic polyisocyanates, such as are described for example by W. Siefken in Justus Liebigs Annalen der Chemie, 562, pages 75 to 136, for example those of formula (V)

Q(NCO)ₙ (V)

in which
n=2-4, preferably 2-3,
and
Q is an aliphatic hydrocarbon radical having 2-18, preferably 6-10, carbon atoms, a cycloaliphatic hydrocarbon radical having 4-15, preferably 6-13, carbon atoms or an araliphatic hydrocarbon radical having 8-15, preferably 8-13, carbon atoms.

Concerned here are, for example, polyisocyanates as described in EP-A 0 007 502, pages 7-8.

Particular preference is generally given to the readily industrially obtainable polyisocyanates, for example 2,4- and 2,6-tolylene diisocyanate and any desired mixtures of these isomers (“TDI”); polyphenylpolymethylene polyisocyanates as prepared by aniline-formaldehyde condensation and subsequent phosgenation (“crude MDI”), and polyisocyanates containing carbodiimide groups, urethane groups, allophanate groups, isocyanurate groups, urea groups or biuret groups (“modified polyisocyanates”), especially those modified polyisocyanates which derive from 2,4- and/or 2,6-tolylene diisocyanate or from 4,4′- and/or 2,4′-diphenylmethane diisocyanate. Preferably employed as component B is at least one compound selected from the group consisting of 2,4- and 2,6-tolylene diisocyanate, 4,4′- and 2,4′- and 2,2′-diphenylmethane diisocyanate and polyphenyl polymethylene polyisocyanate (“polycyclic MDI”).

Very particularly preferably employed as component B is a diphenylmethane diisocyanate mixture consisting of
a) 45% to 90% by weight of 4,4′-diphenylmethane diisocyanate and
b) 10% to 55% by weight of 2,2′-diphenylmethane diisocyanate and/or 2,4′-diphenylmethane diisocyanate and
c) 0% to 45% by weight of polyphenylpolymethylene polyisocyanate (“polycyclic MDI”) and/or 2,2′-, 2,4′-, 4,4′-diphenylmethane diisocyanate-based and/or pMDI-based carbodiimides, uretdiones or uretdioneimines.

Employed as component B in an alternative very particularly preferred embodiment is a diphenylmethane diisocyanate mixture consisting of
a) 35% to 45% by weight of 4,4′-diphenylmethane diisocyanate and
b) 1% to 5% by weight of 2,2′-diphenylmethane diisocyanate and/or 2,4′-diphenylmethane diisocyanate and
c) 50% to 64% by weight of polyphenylpolymethylene polyisocyanate (“polycyclic MDI”) and/or 2,2′-, 2,4′-, 4,4′-diphenylmethane diisocyanate-based and/or pMDI-based carbodiimides, uretdiones or uretdioneimines.

### Performance of the Process for Producing Polyurethane Foams:

The reaction components are reacted by the one-step process known per se, the prepolymer process or the semiprepolymer process often using mechanical means, for example those described in EP-A 355 000. Details of processing apparatuses which are also suitable in accordance with the invention are described in Kunststoff-Handbuch, volume VII, edited by Vieweg and Höchtlen, Carl-Hanser-Verlag, Munich 1993, for example on pages 139 to 265.

The PUR foams may be produced as molded foams or else as slabstock foams.

The molded foams may be produced by hot curing or else cold curing.

The invention therefore provides a process for producing the polyurethane foams, provides the polyurethane foams produced by this process, provides for the use of said foams for producing moldings or slabstocks and provides the moldings/the slabstocks themselves.

The polyurethane foams obtainable according to the invention find use for example in: furniture cushioning, textile inserts, mattresses, automotive seats, headrests, armrests, sponges and constructional elements and also seat and instrument panel trims, and have indices of 70 to 130, preferably 80 to 120, and densities of 4 to 600 kg/m³, preferably 60 to 120 kg/m³ (flexible foam) or preferably 15 bis 55 kg/m³ (semi-flexible foam).

The index (isocyanate index) indicates the percentage ratio of the actually employed isocyanate amount to the stoichiometric, i.e. calculated, isocyanate groups (NCO) amount:

Index=[(employed isocyanate amount):(calculated isocyanate amount)]*100 (VI)

In a first embodiment the invention relates to a process for producing polyurethanes by reaction of compounds containing isocyanate-reactive hydrogen atoms with di- and/or polyisocyanates in the presence of one or more compounds selected from the group consisting of:

NC—CHR¹—CONR¹²—X (I),

NC—CHR²—CONR³-aryl (II),

NC—CHR⁴—CO₂H (III),

[NC—CHR⁵—CO₂]ₘY^{m+} (IV),
wherein
   X represents NR⁶R⁷, OR⁸, CONR⁹R¹⁰ or COOR¹¹,
   R¹ to R¹² each independently of one another represent H, an optionally substituted C₁-C₈ alkyl group or an optionally substituted aryl group,
   Y represents a monovalent or divalent cation and
   m represents 1 or 2.

In a second embodiment the invention relates to a process for producing polyurethanes, preferably polyurethane foams, which comprises reacting with one another
A1 compounds containing isocyanate-reactive hydrogen atoms having an OH number according to DIN 53240 of ≥15 to <260 mg KOH/g,
A2 optionally compounds containing isocyanate-reactive hydrogen atoms having an OH number according to DIN 53240 of ≥260 to <4000 mg KOH/g,
A3 water and/or physical blowing agents,
A4 optionally auxiliary and additive substances such as
   a) catalysts,
   b) surface-active additive substances,
   c) pigments and/or flame retardants,
A5 one or more compounds selected from the group consisting of:

NC—CHR¹—CONR¹²—X (I),

NC—CHR²—CONR³-aryl (II),

NC—CHR⁴—CO₂H (III),

[NC—CHR⁵—CO₂]ₘY^{m+} (IV),
wherein
   X represents NR⁶R⁷, OR⁸, CONR⁹R¹⁰ or COOR¹¹,
   R¹ to R¹² each independently of one another represent H, an optionally substituted C₁-C₈ alkyl group or an optionally substituted aryl group,
   Y represents a monovalent or divalent cation and
   m represents 1 or 2,
and
B di- and/or polyisocyanates.

In a third embodiment of the invention the invention relates to a process according to embodiment 1 or 2, wherein

the usage amount of the compounds (I) to (IV) based on 1 kg of the compounds containing isocyanate-reactive hydrogen atoms and the di- and/or polyisocyanates is 1 to 100 g, preferably 5 to 50 g (claim 1), and the usage amount of the component A5 based on 1 kg of the components A1 and B is 1 to 100 g, preferably 5 to 50 g (claim 2).

In a fourth embodiment of the invention the invention relates to a process for producing polyurethanes, preferably polyurethane foams, according to embodiment 2 or 3 which comprises reacting with one another
A1 75 to 99.0 parts by weight (based on the sum of the parts by weight of components A1 to A4) of compounds containing isocyanate-reactive hydrogen atoms having an OH number according to DIN 53240 of ≥15 to <260 mg KOH/g,
A2 0 to 10 parts by weight (based on the sum of the parts by weight of components A1 to A4) of compounds containing isocyanate-reactive hydrogen atoms having an OH number according to DIN 53240 of ≥260 to <4000 mg KOH/g,
A3 0.5 to 24.5 parts by weight (based on the sum of the parts by weight of components A1 to A4) of water and/or physical blowing agents,
A4 0.5 to 10 parts by weight (based on the sum of the parts by weight of the components A1 to A4) of auxiliaries and additives such as
   a) catalysts,
   b) surface-active additive substances,
   c) pigments and/or flame retardants,
A5 1 to 100 g per kg of the components A1 and B, preferably 5 to 50 g per kg of the components A1 and B, of one or more compounds selected from the group consisting of:

NC—CHR¹—CONR¹²—X (I),

NC—CHR²—CONR³-aryl (II),

NC—CHR⁴—CO₂H (III),

[NC—CHR⁵—CO₂]ₘY^{m+} (IV),
wherein
   X represents NR⁶R⁷, OR, CONR⁹R¹⁰ or COOR¹¹,
   R¹ to R¹² each independently of one another represent H, an optionally substituted C₁-C₈ alkyl group or an optionally substituted aryl group,
   Y represents a monovalent or divalent cation and
   m represents 1 or 2,
and
B di- or polyisocyanates,
wherein all reported parts by weight for the components A1 to A4 are normalized such that the sum of the parts by weight of the components A1+A2+A3+A4 in the composition adds up to 100.

In a fifth embodiment of the invention the invention relates to a process for producing polyurethanes, preferably polyurethane foams, according to embodiment 2 or 3 which comprises reacting with one another
A1 25 to 45 parts by weight (based on the sum of the parts by weight of components A1 to A4) of compounds containing isocyanate-reactive hydrogen atoms having an OH number according to DIN 53240 of ≥15 to <260 mg KOH/g,
A2 20 to 74 parts by weight (based on the sum of the parts by weight of components A1 to A4) of compounds containing isocyanate-reactive hydrogen atoms having an OH number according to DIN 53240 of ≥260 to <4000 mg KOH/g,
A3 0.5 to 25 parts by weight (based on the sum of the parts by weight of components A1 to A4) of water and/or physical blowing agents,
A4 0.5 to 10 parts by weight (based on the sum of the parts by weight of components A1 to A4) of auxiliary and additive substances such as
   a) catalysts,
   b) surface-active additive substances,
   c) pigments and/or flame retardants,
A5 1 to 100 g per kg of the components A1 and B, preferably 5 to 50 g per kg of the components A1 and B (sum of A1 and B), of one or more compounds selected from the group consisting of:

NC—CHR¹—CONR¹²—X (I),

NC—CHR²—CONR³-aryl (II),

NC—CHR⁴—CO₂H (III),

[NC—CHR⁵—CO₂]ₘY^{m+} (IV),
wherein
   X represents NR⁶R⁷, OR⁸, CONR⁹R¹⁰ or COOR¹¹,
   R¹ to R¹² each independently of one another represent H, an optionally substituted C₁-C₈ alkyl group or an optionally substituted aryl group,
   Y represents a monovalent or divalent cation and
   m represents 1 or 2,
and
B di- or polyisocyanates,
wherein all reported parts by weight for the components A1 to A4 are normalized such that the sum of the parts by weight of the components A1+A2+A3+A4 in the composition adds up to 100.

In a sixth embodiment of the invention the invention relates to the use of one or more compounds selected from the group consisting of:

NC—CHR¹—CONR¹²—X (I),

NC—CHR²—CONR³-aryl (II),

NC—CHR⁴—CO₂H (III),

[NC—CHR⁵—CO₂]ₘY^{m+} (IV),
wherein
   X represents NR⁶R⁷, OR⁸, CONR⁹R¹⁰ or COOR¹¹,
   R¹ to R¹² each independently of one another represent H, an optionally substituted C₁-C₈ alkyl group or an optionally substituted aryl group,
   Y represents a monovalent or divalent cation and
   m represents 1 or 2,
in polyurethane compositions or in processes for producing polyurethanes, preferably polyurethane foams, for reducing the formaldehyde emissions of the polyurethanes/polyurethane foams resulting therefrom.

In a seventh embodiment of the invention the invention relates to a process or a use according to any of embodiments 1 to 6, wherein in the compounds (I) to (IV) R¹ to R¹² each independently of one another represent H or a C₁-C₆ alkyl group.

In an eighth embodiment of the invention the invention relates to a process or a use according to claim 7, wherein R¹, R², R⁴ and R⁵ independently of one another represent H.

In a ninth embodiment of the invention the invention relates to a process according to any of embodiments 1 to 5, 7 or 8, wherein as the compounds containing isocyanate-reactive hydrogen atoms (component A1) at least two hydroxyl-containing polyethers, optionally in admixture with at least two hydroxyl-containing polyesters, are employed.

In a tenth embodiment of the invention the invention relates to a process according to any of embodiments 1 to 5, 7 to 9, wherein the component consisting of compounds containing isocyanate-reactive hydrogen atoms (component A1) contains at least 30% by weight of at least one polyoxyalkylene copolymer consisting of a starter, propylene oxide and ethylene oxide and an end block made of ethylene oxide, wherein the total weight of the end blocks made of EO is on average 3-20% by weight, preferably 5-15% by weight, particularly preferably 6-10% by weight, based on the total weight of all polyoxyalkylene copolymers.

In an eleventh embodiment of the invention the invention relates to a process according to any of embodiments 1 to 5 or 7 to 10, wherein as the di- and/or polyisocyanate component (component B) a diphenylmethane diisocyanate mixture consisting of
a) 45% to 90% by weight of 4,4′-diphenylmethane diisocyanate and
b) 10% to 55% by weight of 2,2′-diphenylmethane diisocyanate and/or 2,4′-diphenylmethane diisocyanate and
c) 0% to 45% by weight of polyphenylpolymethylene polyisocyanate (“polycyclic MDI”) and/or 2,2′-, 2,4′-, 4,4′-diphenylmethane diisocyanate-based and/or pMDI-based carbodiimides, uretdiones or uretdioneimines
   is employed.

In a twelfth embodiment of the invention the invention relates to a process according to any of embodiments 1 to 5 or 7 to 10, wherein as the di- and/or polyisocyanate component (component B) a diphenylmethane diisocyanate mixture consisting of
a) 35% to 45% by weight of 4,4′-diphenylmethane diisocyanate and
b) 1% to 5% by weight of 2,2′-diphenylmethane diisocyanate and/or 2,4′-diphenylmethane diisocyanate and
c) 50% to 64% by weight of polyphenylpolymethylene polyisocyanate (“polycyclic MDI”) and/or 2,2′-, 2,4′-, 4,4′-diphenylmethane diisocyanate-based and/or pMDI-based carbodiimides, uretdiones or uretdioneimines
   is employed.

In a thirteenth embodiment of the invention the invention relates to a process for producing polyurethanes, preferably polyurethane foams, according to embodiment 4, 9 or 10 which comprises reacting with one another
A1 75 to 99.0 parts by weight (based on the sum of the parts by weight of components A1 to A4) of compounds containing isocyanate-reactive hydrogen atoms having an OH number according to DIN 53240 of ≥20 to ≤150 mg KOH/g,
A2 0 to 10 parts by weight (based on the sum of the parts by weight of components A1 to A4) of compounds containing isocyanate-reactive hydrogen atoms having an OH number according to DIN 53240 of ≥260 to <4000 mg KOH/g,
A3 0.5 to 24.5 parts by weight (based on the sum of the parts by weight of components A1 to A4) of water and/or physical blowing agents,
A4 0.5 to 10 parts by weight (based on the sum of the parts by weight of components A1 to A4) of auxiliary and additive substances such as
   a) catalysts,
   b) surface-active additive substances,
   c) pigments and/or flame retardants,
A5 5 to 50 g per kg of the components A1 and B (sum of A1 and B) of one or more compounds selected from the group consisting of:

NC—CHR¹—CONR¹²—X (I),

NC—CHR²—CONR³-aryl (II),

NC—CHR⁴—CO₂H (III),

[NC—CHR⁵—CO₂]ₘY^{m+} (IV),
wherein
   X represents NR⁶R⁷, OR, CONR⁹R¹⁰ or COOR¹¹,
   R¹ to R¹² each independently of one another represent H, an optionally substituted C₁-C₈ alkyl group or an optionally substituted aryl group,
   Y represents a monovalent or divalent cation and
   m represents 1 or 2,
and
B di- or polyisocyanates,
wherein all reported parts by weight for the components A1 to A4 are normalized such that the sum of the parts by weight of the components A1+A2+A3+A4 in the composition adds up to 100.

In a fourteenth embodiment of the invention the invention relates to a process for producing polyurethanes, preferably polyurethane foams, according to embodiment 4, 9 or 10 which comprises reacting with one another
A1 75 to 99.0 parts by weight (based on the sum of the parts by weight of components A1 to A4) of compounds containing isocyanate-reactive hydrogen atoms having an OH number according to DIN 53240 of ≥20 to ≤150 mg KOH/g,
A2 0 to 10 parts by weight (based on the sum of the parts by weight of components A1 to A4) of compounds containing isocyanate-reactive hydrogen atoms having an OH number according to DIN 53240 of ≥260 to <4000 mg KOH/g,
A3 0.5 to 24.5 parts by weight (based on the sum of the parts by weight of components A1 to A4) of water and/or physical blowing agents,
A4 0.5 to 10 parts by weight (based on the sum of the parts by weight of components A1 to A4) of auxiliary and additive substances such as
   a) catalysts,
   b) surface-active additive substances,
   c) pigments and/or flame retardants,
A5 5 to 50 g per kg of the components A1 and B (sum of A1 and B) of one or more compounds selected from the group consisting of:

NC—CHR¹—CONR¹²—X (I),

NC—CHR²—CONR³-aryl (II),

NC—CHR⁴—CO₂H (III),

[NC—CHR⁵—CO₂]ₘY^{m+} (IV),
wherein
   X represents NR⁶R⁷, OR⁸, CONR⁹R¹⁰ or COOR¹¹,
   R¹ to R¹² each independently of one another represent H or a C₁-C₆ alkyl group,
   Y represents a monovalent or divalent cation and
   m represents 1 or 2,
and
B di- or polyisocyanates,
wherein all reported parts by weight for the components A1 to A4 are normalized such that the sum of the parts by weight of the components A1+A2+A3+A4 in the composition adds up to 100.

In a fifteenth embodiment of the invention the invention relates to a process for producing polyurethanes, preferably polyurethane foams, according to embodiment 4, 9 or 10 which comprises reacting with one another
A1 75 to 99.0 parts by weight (based on the sum of the parts by weight of components A1 to A4) of compounds containing isocyanate-reactive hydrogen atoms having an OH number according to DIN 53240 of ≥20 to ≤150 mg KOH/g,
A2 0 to 10 parts by weight (based on the sum of the parts by weight of components A1 to A4) of compounds containing isocyanate-reactive hydrogen atoms having an OH number according to DIN 53240 of ≥260 to <4000 mg KOH/g,
A3 0.5 to 24.5 parts by weight (based on the sum of the parts by weight of components A1 to A4) of water and/or physical blowing agents,
A4 0.5 to 10 parts by weight (based on the sum of the parts by weight of components A1 to A4) of auxiliary and additive substances such as
   a) catalysts,
   b) surface-active additive substances,
   c) pigments and/or flame retardants,
A5 5 to 50 g per kg of the components A1 and B (sum of A1 and B) of one or more compounds selected from the group consisting of:

NC—CHR¹—CONR¹²—X (I),

NC—CHR²—CONR³-aryl (II),

NC—CHR⁴—CO₂H (III),

[NC—CHR⁵—CO₂]ₘY^{m+} (IV),
wherein
   X represents NR⁶R⁷, OR⁸, CONR⁹R¹⁰ or COOR¹¹,
   R¹, R², R⁴ and R⁵ each independently of one another represent H and R³ and R⁶ to R¹² each independently of one another represent H or a C₁-C₆ alkyl group,
   Y represents a monovalent or divalent cation and
   m represents 1 or 2,
and
B di- or polyisocyanates,
wherein all reported parts by weight for the components A1 to A4 are normalized such that the sum of the parts by weight of the components A1+A2+A3+A4 in the composition adds up to 100.

In a sixteenth embodiment of the invention the invention relates to a process for producing polyurethanes, preferably polyurethane foams, according to embodiment 4, 9 or 10 which comprises reacting with one another
A1 75 to 99.0 parts by weight (based on the sum of the parts by weight of components A1 to A4) of compounds containing isocyanate-reactive hydrogen atoms having an OH number according to DIN 53240 of ≥20 to ≤150 mg KOH/g,
A2 0 to 10 parts by weight (based on the sum of the parts by weight of components A1 to A4) of compounds containing isocyanate-reactive hydrogen atoms having an OH number according to DIN 53240 of ≥260 to <4000 mg KOH/g,
A3 0.5 to 24.5 parts by weight (based on the sum of the parts by weight of components A1 to A4) of water and/or physical blowing agents,
A4 0.5 to 10 parts by weight (based on the sum of the parts by weight of components A1 to A4) of auxiliary and additive substances such as
   a) catalysts,
   b) surface-active additive substances,
   c) pigments and/or flame retardants,
A5 5 to 50 g per kg of the components A1 and B (sum of A1 and B) of one or more compounds selected from the group consisting of:

NC—CHR¹—CONR¹²—X (I),

NC—CHR²—CONR³-aryl (II),

NC—CHR⁴—CO₂H (III),

[NC—CHR⁵—CO₂]ₘY^{m+} (IV),
wherein
   X represents NR⁶R⁷, OR⁸, CONR⁹R¹⁰ or COOR¹¹,
   R¹ to R¹² each independently of one another represent H or a C₁-C₆ alkyl group,
   Y represents a monovalent or divalent cation and
   m represents 1 or 2,
and
B di- or polyisocyanates,
wherein all reported parts by weight for the components A1 to A4 are normalized such that the sum of the parts by weight of the components A1+A2+A3+A4 in the composition adds up to 100 and employed as component B is a diphenylmethane diisocyanate mixture consisting of
a) 45% to 90% by weight of 4,4′-diphenylmethane diisocyanate and
b) 10% to 55% by weight of 2,2′-diphenylmethane diisocyanate and/or 2,4′-diphenylmethane diisocyanate and
c) 0% to 45% by weight of polyphenylpolymethylene polyisocyanate (“polycyclic MDI”) and/or 2,2′-, 2,4′-, 4,4′-diphenylmethane diisocyanate-based and/or pMDI-based carbodiimides, uretdiones or uretdioneimines.

In a seventeenth embodiment of the invention the invention relates to a process for producing polyurethanes, preferably polyurethane foams, according to embodiment 4, 9 or 10 which comprises reacting with one another
A1 75 to 99.0 parts by weight (based on the sum of the parts by weight of components A1 to A4) of compounds containing isocyanate-reactive hydrogen atoms having an OH number according to DIN 53240 of ≥20 to ≤150 mg KOH/g,
A2 0 to 10 parts by weight (based on the sum of the parts by weight of components A1 to A4) of compounds containing isocyanate-reactive hydrogen atoms having an OH number according to DIN 53240 of ≥260 to <4000 mg KOH/g,
A3 0.5 to 24.5 parts by weight (based on the sum of the parts by weight of components A1 to A4) of water and/or physical blowing agents,
A4 0.5 to 10 parts by weight (based on the sum of the parts by weight of components A1 to A4) of auxiliary and additive substances such as
   a) catalysts,
   b) surface-active additive substances,
   c) pigments and/or flame retardants,
A5 5 to 50 g per kg of the components A1 and B (sum of A1 and B) of one or more compounds selected from the group consisting of:

NC—CHR¹—CONR¹²—X (I),

NC—CHR²—CONR³-aryl (II),

NC—CHR⁴—CO₂H (III),

[NC—CHR⁵—CO₂]ₘY^{m+} (IV),
wherein
   X represents NR⁶R⁷, OR⁸, CONR⁹R¹⁰ or COOR¹¹,
   R¹ to R¹² each independently of one another represent H or a C₁-C₆ alkyl group,
   Y represents a monovalent or divalent cation and
   m represents 1 or 2,
and
B di- or polyisocyanates,
wherein all reported parts by weight for the components A1 to A4 are normalized such that the sum of the parts by weight of the components A1+A2+A3+A4 in the composition adds up to 100 and employed as component B is a diphenylmethane diisocyanate mixture consisting of
a) 35% to 45% by weight of 4,4′-diphenylmethane diisocyanate and
b) 1% to 5% by weight of 2,2′-diphenylmethane diisocyanate and/or 2,4′-diphenylmethane diisocyanate and
c) 50% to 64% by weight of polyphenylpolymethylene polyisocyanate (“polycyclic MDI”) and/or 2,2′-, 2,4′-, 4,4′-diphenylmethane diisocyanate-based and/or pMDI-based carbodiimides, uretdiones or uretdioneimines.

In an eighteenth embodiment of the invention the invention relates to a process for producing polyurethanes, preferably polyurethane foams, according to embodiment 4, 9 or 10 which comprises reacting with one another
A1 75 to 99.0 parts by weight (based on the sum of the parts by weight of components A1 to A4) of compounds containing isocyanate-reactive hydrogen atoms having an OH number according to DIN 53240 of ≥20 to ≤150 mg KOH/g,
A2 0 to 10 parts by weight (based on the sum of the parts by weight of components A1 to A4) of compounds containing isocyanate-reactive hydrogen atoms having an OH number according to DIN 53240 of ≥260 to <4000 mg KOH/g,
A3 0.5 to 24.5 parts by weight (based on the sum of the parts by weight of components A1 to A4) of water and/or physical blowing agents,
A4 0.5 to 10 parts by weight (based on the sum of the parts by weight of components A1 to A4) of auxiliary and additive substances such as
   a) catalysts,
   b) surface-active additive substances,
   c) pigments and/or flame retardants,
A5 5 to 50 g per kg of the components A1 and B (sum of A1 and B) of one or more compounds selected from the group consisting of:

NC—CHR¹—CONR¹²—X (I),

NC—CHR²—CONR³-aryl (II),

NC—CHR⁴—CO₂H (III),

[NC—CHR⁵—CO₂]ₘY^{m+} (IV),
wherein
   X represents NR⁶R⁷, OR, CONR⁹R¹⁰ or COOR¹¹,
   R¹, R², R⁴ and R⁵ each independently of one another represent H and R³ and R⁶ to R¹² each independently of one another represent H or a C₁-C₆ alkyl group,
   Y represents a monovalent or divalent cation and
   m represents 1 or 2,
and
B di- or polyisocyanates,
wherein all reported parts by weight for the components A1 to A4 are normalized such that the sum of the parts by weight of the components A1+A2+A3+A4 in the composition adds up to 100 and employed as component B is a diphenylmethane diisocyanate mixture consisting of
a) 45% to 90% by weight of 4,4′-diphenylmethane diisocyanate and
b) 10% to 55% by weight of 2,2′-diphenylmethane diisocyanate and/or 2,4′-diphenylmethane diisocyanate and
c) 0% to 45% by weight of polyphenylpolymethylene polyisocyanate (“polycyclic MDI”) and/or 2,2′-, 2,4′-, 4,4′-diphenylmethane diisocyanate-based and/or pMDI-based carbodiimides, uretdiones or uretdioneimines.

In a nineteenth embodiment of the invention the invention relates to a process for producing polyurethanes, preferably polyurethane foams, according to embodiment 4, 9 or 10 which comprises reacting with one another
A1 75 to 99.0 parts by weight (based on the sum of the parts by weight of components A1 to A4) of compounds containing isocyanate-reactive hydrogen atoms having an OH number according to DIN 53240 of ≥20 to ≤150 mg KOH/g,
A2 0 to 10 parts by weight (based on the sum of the parts by weight of components A1 to A4) of compounds containing isocyanate-reactive hydrogen atoms having an OH number according to DIN 53240 of ≥260 to <4000 mg KOH/g,
A3 0.5 to 24.5 parts by weight (based on the sum of the parts by weight of components A1 to A4) of water and/or physical blowing agents,
A4 0.5 to 10 parts by weight (based on the sum of the parts by weight of components A1 to A4) of auxiliary and additive substances such as
   a) catalysts,
   b) surface-active additive substances,
   c) pigments and/or flame retardants,
A5 5 to 50 g per kg of the components A1 and B (sum of A1 and B) of one or more compounds selected from the group consisting of:

NC—CHR¹—CONR¹²—X (I),

NC—CHR²—CONR³-aryl (II),

NC—CHR⁴—CO₂H (III),

[NC—CHR⁵—CO₂]ₘY^{m+} (IV),
wherein
   X represents NR⁶R⁷, OR⁸, CONR⁹R¹⁰ or COOR¹¹,
   R¹, R², R⁴ and R⁵ each independently of one another represent H and R³ and R⁶ to R¹² each independently of one another represent H or a C₁-C₆ alkyl group,
   Y represents a monovalent or divalent cation and
   m represents 1 or 2,
and
B di- or polyisocyanates,
wherein all reported parts by weight for the components A1 to A4 are normalized such that the sum of the parts by weight of the components A1+A2+A3+A4 in the composition adds up to 100 and employed as component B is a diphenylmethane diisocyanate mixture consisting of
a) 35% to 45% by weight of 4,4′-diphenylmethane diisocyanate and
b) 1% to 5% by weight of 2,2′-diphenylmethane diisocyanate and/or 2,4′-diphenylmethane diisocyanate and
c) 50% to 64% by weight of polyphenylpolymethylene polyisocyanate (“polycyclic MDI”) and/or 2,2′-, 2,4′-, 4,4′-diphenylmethane diisocyanate-based and/or pMDI-based carbodiimides, uretdiones or uretdioneimines.

In a twentieth embodiment of the invention the invention relates to a process for producing polyurethanes, preferably polyurethane foams, according to embodiment 5, 9 or 10 which comprises reacting with one another
A1 25 to 45 parts by weight (based on the sum of the parts by weight of components A1 to A4) of compounds containing isocyanate-reactive hydrogen atoms having an OH number according to DIN 53240 of ≥20 to ≤150 mg KOH/g,
A2 20 to 74 parts by weight (based on the sum of the parts by weight of components A1 to A4) of compounds containing isocyanate-reactive hydrogen atoms having an OH number according to DIN 53240 of ≥260 to <4000 mg KOH/g,
A3 0.5 to 25 parts by weight (based on the sum of the parts by weight of components A1 to A4) of water and/or physical blowing agents,
A4 0.5 to 10 parts by weight (based on the sum of the parts by weight of components A1 to A4) of auxiliary and additive substances such as
   a) catalysts,
   b) surface-active additive substances,
   c) pigments and/or flame retardants,
A5 5 to 50 g per kg of the components A1 and B (sum of A1 and B) of one or more compounds selected from the group consisting of:

NC—CHR¹—CONR¹²—X (I),

NC—CHR²—CONR³-aryl (II),

NC—CHR⁴—CO₂H (III),

[NC—CHR⁵—CO₂]ₘY^{m+} (IV),
wherein
   X represents NR⁶R⁷, OR, CONR⁹R¹⁰ or COOR¹¹,
   R¹ to R¹² each independently of one another represent H, an optionally substituted C₁-C₈ alkyl group or an optionally substituted aryl group,
   Y represents a monovalent or divalent cation and
   m represents 1 or 2,
and
B di- or polyisocyanates,
wherein all reported parts by weight for the components A1 to A4 are normalized such that the sum of the parts by weight of the components A1+A2+A3+A4 in the composition adds up to 100.

In a twenty-first embodiment of the invention the invention relates to a process for producing polyurethanes, preferably polyurethane foams, according to embodiment 5, 9 or 10 which comprises reacting with one another
A1 25 to 45 parts by weight (based on the sum of the parts by weight of components A1 to A4) of compounds containing isocyanate-reactive hydrogen atoms having an OH number according to DIN 53240 of ≥20 to ≤150 mg KOH/g,
A2 20 to 74 parts by weight (based on the sum of the parts by weight of components A1 to A4) of compounds containing isocyanate-reactive hydrogen atoms having an OH number according to DIN 53240 of ≥260 to <4000 mg KOH/g,
A3 0.5 to 25 parts by weight (based on the sum of the parts by weight of components A1 to A4) of water and/or physical blowing agents,
A4 0.5 to 10 parts by weight (based on the sum of the parts by weight of components A1 to A4) of auxiliary and additive substances such as
   a) catalysts,
   b) surface-active additive substances,
   c) pigments and/or flame retardants,
A5 5 to 50 g per kg of the components A1 and B (sum of A1 and B) of one or more compounds selected from the group consisting of:

NC—CHR¹—CONR¹²—X (I),

NC—CHR²—CONR³-aryl (II),

NC—CHR⁴—CO₂H (III),

[NC—CHR⁵—CO₂]ₘY^{m+} (IV),
wherein
   X represents NR⁶R⁷, OR⁸, CONR⁹R¹⁰ or COOR¹¹,
   R¹ to R¹² each independently of one another represent H or each independently of one another represent H or a C₁-C₆ alkyl group,
   Y represents a monovalent or divalent cation and
   m represents 1 or 2,
and
B di- or polyisocyanates,
wherein all reported parts by weight for the components A1 to A4 are normalized such that the sum of the parts by weight of the components A1+A2+A3+A4 in the composition adds up to 100.

In a twenty-second embodiment of the invention the invention relates to a process for producing polyurethanes, preferably polyurethane foams, according to embodiment 5, 9 or 10 which comprises reacting with one another
A1 25 to 45 parts by weight (based on the sum of the parts by weight of components A1 to A4) of compounds containing isocyanate-reactive hydrogen atoms having an OH number according to DIN 53240 of ≥20 to ≤150 mg KOH/g,
A2 20 to 74 parts by weight (based on the sum of the parts by weight of components A1 to A4) of compounds containing isocyanate-reactive hydrogen atoms having an OH number according to DIN 53240 of ≥260 to <4000 mg KOH/g,
A3 0.5 to 25 parts by weight (based on the sum of the parts by weight of components A1 to A4) of water and/or physical blowing agents,
A4 0.5 to 10 parts by weight (based on the sum of the parts by weight of components A1 to A4) of auxiliary and additive substances such as
   a) catalysts,
   b) surface-active additive substances,
   c) pigments and/or flame retardants,
A5 5 to 50 g per kg of the components A1 and B (sum of A1 and B) of one or more compounds selected from the group consisting of:

NC—CHR¹—CONR¹²—X (I),

NC—CHR²—CONR³-aryl (II),

NC—CHR⁴—CO₂H (III),

[NC—CHR⁵—CO₂]ₘY^{m+} (IV),
wherein
   X represents NR⁶R⁷, OR⁸, CONR⁹R¹⁰ or COOR¹¹,
   R¹, R², R⁴ and R⁵ each independently of one another represent H and R³ and R⁶ to R¹² each independently of one another represent H or a C₁-C₆ alkyl group,
   Y represents a monovalent or divalent cation and
   m represents 1 or 2,
and
B di- or polyisocyanates,
wherein all reported parts by weight for the components A1 to A4 are normalized such that the sum of the parts by weight of the components A1+A2+A3+A4 in the composition adds up to 100.

In a twenty-third embodiment of the invention the invention relates to a process for producing polyurethanes, preferably polyurethane foams, according to embodiment 5, 9 or 10 which comprises reacting with one another
A1 25 to 45 parts by weight (based on the sum of the parts by weight of components A1 to A4) of compounds containing isocyanate-reactive hydrogen atoms having an OH number according to DIN 53240 of ≥20 to ≤150 mg KOH/g,
A2 20 to 74 parts by weight (based on the sum of the parts by weight of components A1 to A4) of compounds containing isocyanate-reactive hydrogen atoms having an OH number according to DIN 53240 of ≥260 to <4000 mg KOH/g,
A3 0.5 to 25 parts by weight (based on the sum of the parts by weight of components A1 to A4) of water and/or physical blowing agents,
A4 0.5 to 10 parts by weight (based on the sum of the parts by weight of components A1 to A4) of auxiliary and additive substances such as
   a) catalysts,
   b) surface-active additive substances,
   c) pigments and/or flame retardants,
A5 5 to 50 g per kg of the components A1 and B (sum of A1 and B) of one or more compounds selected from the group consisting of:

NC—CHR¹—CONR¹²—X (I),

NC—CHR²—CONR³-aryl (II),

NC—CHR⁴—CO₂H (III),

[NC—CHR⁵—CO₂]ₘY^{m+} (IV),
wherein
   X represents NR⁶R⁷, OR⁸, CONR⁹R¹⁰ or COOR¹¹,
   R¹ to R¹² each independently of one another represent H or each independently of one another represent H or a C₁-C₆ alkyl group,
   Y represents a monovalent or divalent cation and
   m represents 1 or 2,
and
B di- or polyisocyanates,
wherein all reported parts by weight for the components A1 to A4 are normalized such that the sum of the parts by weight of the components A1+A2+A3+A4 in the composition adds up to 100 and employed as component B is a diphenylmethane diisocyanate mixture consisting of
a) 45% to 90% by weight of 4,4′-diphenylmethane diisocyanate and
b) 10% to 55% by weight of 2,2′-diphenylmethane diisocyanate and/or 2,4′-diphenylmethane diisocyanate and
c) 0% to 45% by weight of polyphenylpolymethylene polyisocyanate (“polycyclic MDI”) and/or 2,2′-, 2,4′-, 4,4′-diphenylmethane diisocyanate-based and/or pMDI-based carbodiimides, uretdiones or uretdioneimines.

In a twenty-fourth embodiment of the invention the invention relates to a process for producing polyurethanes, preferably polyurethane foams, according to embodiment 5, 9 or 10 which comprises reacting with one another
A1 25 to 45 parts by weight (based on the sum of the parts by weight of components A1 to A4) of compounds containing isocyanate-reactive hydrogen atoms having an OH number according to DIN 53240 of ≥20 to ≤150 mg KOH/g,
A2 20 to 74 parts by weight (based on the sum of the parts by weight of components A1 to A4) of compounds containing isocyanate-reactive hydrogen atoms having an OH number according to DIN 53240 of ≥260 to <4000 mg KOH/g,
A3 0.5 to 25 parts by weight (based on the sum of the parts by weight of components A1 to A4) of water and/or physical blowing agents,
A4 0.5 to 10 parts by weight (based on the sum of the parts by weight of components A1 to A4) of auxiliary and additive substances such as
   a) catalysts,
   b) surface-active additive substances,
   c) pigments and/or flame retardants,
A5 5 to 50 g per kg of the components A1 and B (sum of A1 and B) of one or more compounds selected from the group consisting of:

NC—CHR¹—CONR¹²—X (I),

NC—CHR²—CONR³-aryl (II),

NC—CHR⁴—CO₂H (III),

[NC—CHR⁵—CO₂]ₘY^{m+} (IV),
wherein
   X represents NR⁶R⁷, OR⁸, CONR⁹R¹⁰ or COOR¹¹,
   R¹ to R¹² each independently of one another represent H or each independently of one another represent H or a C₁-C₆ alkyl group,
   Y represents a monovalent or divalent cation and
   m represents 1 or 2,
and
B di- or polyisocyanates,
wherein all reported parts by weight for the components A1 to A4 are normalized such that the sum of the parts by weight of the components A1+A2+A3+A4 in the composition adds up to 100 and employed as component B is a diphenylmethane diisocyanate mixture consisting of
a) 35% to 45% by weight of 4,4′-diphenylmethane diisocyanate and
b) 1% to 5% by weight of 2,2′-diphenylmethane diisocyanate and/or 2,4′-diphenylmethane diisocyanate and
c) 50% to 64% by weight of polyphenylpolymethylene polyisocyanate (“polycyclic MDI”) and/or 2,2′-, 2,4′-, 4,4′-diphenylmethane diisocyanate-based and/or pMDI-based carbodiimides, uretdiones or uretdioneimines.

In a twenty-fifth embodiment of the invention the invention relates to a process for producing polyurethanes, preferably polyurethane foams, according to embodiment 5, 9 or 10 which comprises reacting with one another
A1 25 to 45 parts by weight (based on the sum of the parts by weight of components A1 to A4) of compounds containing isocyanate-reactive hydrogen atoms having an OH number according to DIN 53240 of ≥20 to ≤150 mg KOH/g,
A2 20 to 74 parts by weight (based on the sum of the parts by weight of components A1 to A4) of compounds containing isocyanate-reactive hydrogen atoms having an OH number according to DIN 53240 of ≥260 to <4000 mg KOH/g,
A3 0.5 to 25 parts by weight (based on the sum of the parts by weight of components A1 to A4) of water and/or physical blowing agents,
A4 0.5 to 10 parts by weight (based on the sum of the parts by weight of components A1 to A4) of auxiliary and additive substances such as
   a) catalysts,
   b) surface-active additive substances,
   c) pigments and/or flame retardants,
A5 5 to 50 g per kg of the components A1 and B (sum of A1 and B) of one or more compounds selected from the group consisting of:

NC—CHR¹—CONR¹²—X (I),

NC—CHR²—CONR³-aryl (II),

NC—CHR⁴—CO₂H (III),

[NC—CHR⁵—CO₂]ₘY^{m+} (IV),
wherein
   X represents NR⁶R⁷, OR⁸, CONR⁹R¹⁰ or COOR¹¹,
   R¹, R², R⁴ and R⁵ each independently of one another represent H and R³ and R⁶ to R¹² each independently of one another represent H or a C₁-C₆ alkyl group,
   Y represents a monovalent or divalent cation and
   m represents 1 or 2,
and
B di- or polyisocyanates,
wherein all reported parts by weight for the components A1 to A4 are normalized such that the sum of the parts by weight of the components A1+A2+A3+A4 in the composition adds up to 100 and employed as component B is a diphenylmethane diisocyanate mixture consisting of
a) 45% to 90% by weight of 4,4′-diphenylmethane diisocyanate and
b) 10% to 55% by weight of 2,2′-diphenylmethane diisocyanate and/or 2,4′-diphenylmethane diisocyanate and
c) 0% to 45% by weight of polyphenylpolymethylene polyisocyanate (“polycyclic MDI”) and/or 2,2′-, 2,4′-, 4,4′-diphenylmethane diisocyanate-based and/or pMDI-based carbodiimides, uretdiones or uretdioneimines.

In a twenty-sixth embodiment of the invention the invention relates to a process for producing polyurethanes, preferably polyurethane foams, according to embodiment 5, 9 or 10 which comprises reacting with one another
A1 25 to 45 parts by weight (based on the sum of the parts by weight of components A1 to A4) of compounds containing isocyanate-reactive hydrogen atoms having an OH number according to DIN 53240 of ≥20 to ≤150 mg KOH/g,
A2 20 to 74 parts by weight (based on the sum of the parts by weight of components A1 to A4) of compounds containing isocyanate-reactive hydrogen atoms having an OH number according to DIN 53240 of ≥260 to <4000 mg KOH/g,
A3 0.5 to 25 parts by weight (based on the sum of the parts by weight of components A1 to A4) of water and/or physical blowing agents,
A4 0.5 to 10 parts by weight (based on the sum of the parts by weight of components A1 to A4) of auxiliary and additive substances such as
   a) catalysts,
   b) surface-active additive substances,
   c) pigments and/or flame retardants,
A5 5 to 50 g per kg of the components A1 and B (sum of A1 and B) of one or more compounds selected from the group consisting of:

NC—CHR¹—CONR¹²—X (I),

NC—CHR²—CONR³-aryl (II),

NC—CHR⁴—CO₂H (III),

[NC—CHR⁵—CO₂]ₘY^{m+} (IV),
wherein
   X represents NR⁶R⁷, OR⁸, CONR⁹R¹⁰ or COOR¹¹,
   R¹, R², R⁴ and R⁵ each independently of one another represent H and R³ and R⁶ to R¹² each independently of one another represent H or a C₁-C₆ alkyl group,
   Y represents a monovalent or divalent cation and
   m represents 1 or 2,
and
B di- or polyisocyanates,
wherein all reported parts by weight for the components A1 to A4 are normalized such that the sum of the parts by weight of the components A1+A2+A3+A4 in the composition adds up to 100 and employed as component B is a diphenylmethane diisocyanate mixture consisting of
a) 35% to 45% by weight of 4,4′-diphenylmethane diisocyanate and
b) 1% to 5% by weight of 2,2′-diphenylmethane diisocyanate and/or 2,4′-diphenylmethane diisocyanate and
c) 50% to 64% by weight of polyphenylpolymethylene polyisocyanate (“polycyclic MDI”) and/or 2,2′-, 2,4′-, 4,4′-diphenylmethane diisocyanate-based and/or pMDI-based carbodiimides, uretdiones or uretdioneimines.

In a twenty-seventh embodiment of the invention the invention relates to polyurethanes/polyurethane foams obtainable by a process according to any of the embodiments 1 to 5 or 7 to 26.

In a twenty-eighth embodiment of the invention the invention relates to polyurethanes/polyurethane foams according to embodiment 27 having a density of 4 to 600 kg/m³ (flexible/semi-flexible polyurethane from), preferably 60 to 120 kg/m³ (flexible polyurethane foam) and preferably 15 to 55 kg/m³ (semi-flexible foam)

In a twenty-ninth embodiment of the invention the invention relates to polyurethanes/polyurethane foams according to embodiment 27 or 28 for producing furniture cushioning, textile inlays, mattresses, automotive seats, headrests, armrests, sponges, headlinings, door trims, seat covers or constructional elements.

### EXAMPLES

### Test Methods:

Compressive strength, damping and apparent density of the foams were determined in the foam expansion direction according to DIN EN ISO 3386-1. The test specimens had a volume of 5*5*5 cm³. A pre-loading of 2 kPa was established. The advancing rate was 50 mm/min.

The hydroxyl number was determined according to DIN 53240.

The open-cell content was measured with an AccuPyc 1330 gas displacement pycnometer.

The glass transition reported is the maximum of tan 6 according to DIN EN ISO 6721-2 B (torsion pendulum method).

### Determination of Aldehyde Emissions:

VDA 275 is a standardized test method of the organization Verband der Automobilindustrie (VDA). The version current at the date of filing is employed here.
a) measurement method 1 (bottle method according to VDA 275):
   Charged into a glass bottle of 1 liter in volume are 50 milliliters of water. A foam sheet having dimensions of 40*10*2 cm³ is fixed freely suspended from the lid so that the foam is not in contact with the aqueous solution at the bottom of the bottle. The bottle is closed and stored in a recirculating air drying cabinet at 60° C. for 3 hours. The bottle is allowed to cool to room temperature and the foam is withdrawn. An aliquot of the aqueous solution is reacted with a solution of 0.3 mmol/liter of dinitrophenylhydrazine (DNPH) in 3 mM phosphoric acid-acidified acetonitrile. The composition of the aqueous solution is analyzed by LC-MS/MS for the hydrazones of the aldehydes recited below. For each foam quality three bottles are analyzed. For each test run a further three bottles without foam are coanalyzed. The average reference value is subtracted from the measured values. The emission of the respective aldehydes per kilogram of foam are extrapolated on this basis. This is reported in mg of aldehyde per kg of foam.
b) measurement method 2 (modified bottle method):
   Charged into a glass bottle of one liter in volume are 25 milliliters of water and 25 millilitres of a solution of 0.3 mmol/liter of dinitrophenylhydrazine (DNPH) in 3 mM phosphoric acid-acidified acetonitrile. The content of DNPH is 7.5 μmol per bottle. A foam sheet having dimensions of 40*10*4 cm³ is fixed freely suspended from the lid so that the foam is not in contact with the aqueous solution at the bottom of the bottle. The bottle is closed and stored in a recirculating air drying cabinet at 65° C. for 3 hours. The bottle is allowed to cool to room temperature, the foam is withdrawn and the composition of the aqueous solution is analyzed by LC/MS-MS for the hydazones of the aldehydes recited below. For each foam quality three bottles are analyzed. For each test run a further three bottles without foam are coanalyzed. The average reference value is subtracted from the measured values. The emission of the respective aldehydes per kilogram of foam are extrapolated on this basis. This is reported in mg of aldehyde per kg of foam.

### Description of Tests

The production of the polyurethane foams is carried out by mixing a polyol formulation A and an isocyanate component B.

The reported OH numbers are obtained according to DIN 53240 in the version current at the date of filing.

### Test Series 1: Molded Flexible Foam, for Example for Sound Absorption

### Description of Raw Materials

A1-1: Polyether mixture of a glycerol-started polyalkylene oxide having a molar weight of 4.8 kg/mol, an OH number of 35 mg KOH/g and a content of ethylene oxide of <50% by weight and a propylene glycol-started polyalkylene oxide having a molar weight of 4 kg/mol and an OH number of 28 mg KOH/g in a weight ratio of 55:45.
A2-1: Triethanolamine
A3-1: Water
A4-1: Isopur N black colour paste, commercially available from
A4-2: Tegostab B8734 LF2 foam stabilizer, commercially available from Evonik Nutrition & Care, Essen
A4-3: Glycerol-started polyalkylene oxide having an OH number of 37 mg KOH/g and a content of ethylene oxide of ≥50% by weight used as a cell-opener
A4-4: Catalyst mixture of Jeffcat® DPA (commercially available from Huntsman) and Dabco® NE 300 (commercially available from Air Products) in a ratio of 6:1 (by weight)
A5-1: Cyanoacetic acid 67% in DEG (diethylene glycol)
B-1: Mixture of MDI isomers and homologs having a density of 1.24 kg/l, an isocyanate content of 323 g/kg and a viscosity of 0.05 Pa*s. The content of 4,4′-MDI is 55% by weight. The sum of 2,2′-MDI, 2,4′-MDI and 4,4′-MDI is 70% by weight.

Polyol formulation A

| | Comparative | Inventive |
|---|---|---|
| | 90V | 90A |
| Polyether mixture (A1-1) | 91.7 | 87.8 |
| Cell opener (A4-3) | 1.5 | 1.5 |
| Colour paste (A4-1) | 0.2 | 0.2 |
| Foam stabilizer (A4-2) | 0.8 | 0.7 |
| Crosslinker (A2-1) | 0.6 | 0.6 |
| Blowing agent (A3-1) | 3.8 | 3.7 |
| Catalyst (A4-4) | 1.4 | 2.6 |
| Cyanoacetic acid 67% in DEG (A5-1) | — | 2.9 |

### Production of the Foams:

The ratio of isocyanate groups to isocyanate-reactive groups multiplied by 100 is described as the index. The following tests always compare foams produced using the same index. In two test series an index below 100 (excess of isocyanate-reactive groups) and an index above 100 were established.

| | Polyol component | Isocyanate | Isocyanate |
|---|---|---|---|
| | usage amount | usage amount | usage amount |
| | grams | grams | grams |
| Index 90 | | | |
| Foam 90V | 100 | 59 | |
| Foam 90A | 100 | | 61 |
| Index 105 | | | |
| Foam 105V | 100 | 69 | |
| Foam 105A | 100 | | 71 |

To produce the foams the required amount of polyol is initially charged into a cardboard beaker having a sheet metal bottom (volume: about 850 ml) and loaded with air using a stirring means (Pendraulik) fitted with a standard stirring disk (d=64 mm) at 4200 rpm for 45 seconds.

The isocyanate/isocyanate mixture/prepolymer is weighed into a suitable beaker and emptied again (efflux time: 3 s). This beaker still having wet internal walls is tared and refilled with the reported isocyanate quantity. The isocyanate is added to the polyol formulation (efflux time: 3 s). The mixture is subjected to intensive mixing for 5 seconds using a stirring means (Pendraulik). A stopwatch is started at commencement of the mixing and the characteristic reaction times are read-off therefrom. About 93 g of the reaction mixture are poured into a teflon film-lined aluminum box mold having a volume of 1.6 dm³ and a temperature of 23° C. The mold is closed and locked. After six minutes the mold is unlocked, decompressed and the mold pressure is qualitatively assessed via the height by which the mold lid has been raised by the molding [mm]. The demolded foam cushion is qualitatively assessed for reaction completeness and for skin and pore structure.

The reaction kinetics are determined using the residual reaction mixture in the beaker.

The cream time has been attained when an expanding of the mixture is observable.

The fiber time has been attained when strings can be pulled from the surface of the rising foam by dabbing with a wooden spatula. Alternatively, lumps form on the spatula.

The rise time has been attained when the foam finally ceases to expand. It should be noted here that some systems have a propensity to undergo some sagging before rising again.

| | | 90V | 90A | 105V |
|---|---|---|---|---|
| Reaction kinetics | | Comparative | Inventive | Comparative |
| Cream time | seconds | 10 | 8 | 10 |
| Fiber time | seconds | 50 | 55 | 52 |
| Rise time | seconds | 69 | 80 | 80 |

### Conditioning of the Foams:

After production all foams were stored in a fume cupboard at 20-23° C. for 7 days.

Some of the foams were packaged in aluminum foil and stored in a circulating air drying cabinet at 90° C. before measurement of the aldehyde emissions. These foams are described as “aged”.

### Mechanical Characterization of the Foams

The compressive strength was measured at 40% compression parallel to the foaming direction. A pre-loading of 2 kPa was established. The advancing rate was 50 mm/min.

| | 90V | 105V | 90A | |
|---|---|---|---|---|
| | Compar- | Compar- | Inven- | |
| | ative | ative | tive | |
| Apparent density | | | | |
| Before ageing | 49 | 50 | 48 | Kg/m³ |
| After 7 days at 110° C. | 49 | 50 | 49 | Kg/m³ |
| Compressive strength at 40% | | | | |
| compression | | | | |
| Before ageing | 8.4 | 11.7 | 8.7 | kPa |
| After 7 days at 110° C. | 8.2 | 11.7 | 8.6 | kPa |
| Damping at 40% compression | | | | |
| Before ageing | 0.42 | 0.47 | 0.38 | |
| After 7 days at 110° C. | 0.41 | 0.47 | 0.39 | |

### Aldehyde Emissions

### Measurement Method 1 (Bottle Method According to VDA 275):

| | | 90 V | 105V | 90 A |
|---|---|---|---|---|
| VDA275 | | Comparative | Comparative | Inventive |
| Formaldehyde | mg/kg | 4.2 | 3.6 | 3.8 |

The familiar effect that increasing the index reduces aldehyde emissions is observed. At an identical index the foams according to the invention show moderately to markedly reduced aldehyde emissions.

### Test Method 2 (Modified Bottle Method):

| | | 90 V | 105V | 90 A |
|---|---|---|---|---|
| Formaldehyde | | Comparative | Comparative | Inventive |
| Before ageing | mg/kg | 7.0 | 6.1 | 5.3 |
| After 7 days at 90° C. | mg/kg | 8.8 | 9.8 | 7.8 |

The modified method increases the visibility of formaldehyde. Surprisingly, the ageing results in a reversing of the initially positive effect of a higher index.

Before and after aging the addition of cyanoacetic acid has a positive effect on formaldehyde emissions.

### Test Series 2: Semi-Rigid Slabstock Foam, for Example for Sound Absorption

(Delimitation from EP 1674515)

### Description of Raw Materials

(A1/A2)-1: Polyether mixture of a glycerol/sorbitol-co-started polyalkylene oxide having an equivalent weight of 1.8 kg/mol and an OH number of 31 mg KOH/g, a glycerol-started polyalkylene oxide having an equivalent weight of 0.1 kg/mol and an OH number of 560 mg KOH/g and a propylene glycol-started polyalkylene oxide having an equivalent weight of 0.2 kg/mol and an OH number of 280 mg KOH/g in a weight ratio of 38:50:12.
A2-2: Glycerol
A3-1: Water
A4-5: Polyether-polydimethylsilicone foam stabilizer
A4-6: Catalyst: Reaction product of oleic acid and dimethylaminopropylamine (1:1 molar)
A5-2: Acethydrazide
A5-3: Cyanoacethydrazide
A5-4: DHBH: Reaction product of hydrazine hydrate und cyclic propylene carbonate (1:2 molar)
A5-5: CMPA: 2-cyano-N-methyl-N-phenylacetamide
A5-6: KCA: Potassium cyanoacetate
B-2: Mixture of MDI isomers and homologs having a density of 1.22 kg/l, an isocyanate content of 322 g/kg and a viscosity of 0.05 Pa*s. The content of 4,4′-MDI is 47% by weight. The sum of 2,2′-MDI, 2,4′-MDI and 4,4′-MDI is 70%.

| | % by weight in polyol |
|---|---|
| | formulation |
| Polyether mixture (A1/A2)-1 | 82.0 |
| Polyether-polydimethylsilicone foam | 1.5 |
| stabilizer A4-5 | |
| Crosslinker A2-2 | 7.0 |
| Blowing agent A3-1 | 6.5 |
| Catalyst A4-6 | 3.0 |

### Additives A5 in Polyol Formulation:

| | 90 V2 | 90 V3 | 90 C | 90 D | 90 V4 | 90 V5 | 90 E | 90 F |
|---|---|---|---|---|---|---|---|---|
| | Comparative | | Inventive | | Comparative | | Inventive | |
| | CH₃—CO—NH—NH₂ | | A5-NC—CH₂—CO—NH—CO—NH₂ | | DHBH | | CMPA | KCA |
| Type | A5-2 | | A5-3 | | A5-4 | None | A5-5 | A5-6 |
| Content in | 7.1 | 7.1 | 7.7 | 7.1 | 7.7 | — | 7.7 | 7.7 |
| g/kg | | | | | | | | |
| Content in | 96 | 96 | 61 | 56 | 33 | — | 44 | 63 |
| mmol/kg | | | | | | | | |
| Addition as | Solution in | Solution in | Solid | Suspension in | Liquid | | Solid | Solution in |
| | blowing agent | crosslinker | | crosslinker | | | | blowing |
| | | | | | | | | agent |

The content is reported in % by weight. DHBH is the reaction product of hydrazine hydrate and cyclic propylene carbonate (1:2 molar), KCA is potassium cyanoacetate K+[NC—CH₂—CO₂]⁻. CMPA is 2-cyano-N-methyl-N-phenylacetamide NC—CH₂—CO—N(CH₃)(C₆H₅)

All foams are produced with an index of 90.

### Mechanical Characterization of the Foams

| | | 90 V2 | 90 V3 | 90 B | 90 C | 90 V4 | 90 V5 | 90D | 90 E |
|---|---|---|---|---|---|---|---|---|---|
| | | Comparative | | Inventive | | Comparative | | Inventive | |
| Density | Kg/m³ | 26 | 24 | 24 | 25 | 24 | 21 | 27 | 22 |
| ε | | 6.6% | 6.1% | 7.0% | 7.4% | 5.2% | 5.4% | 5.3% | 3.2% |
| Modulus | kPa | 103 | 91 | 112 | 122 | 112 | 94 | 122 | 79 |
| Maximum | kPa | 82 | 79 | 93 | 101 | 92 | 82 | 124 | |
| force | | | | | | | | | |

The compressive strength was measured at 10% compression parallel to the foaming direction.

The inventive examples show a somewhat higher hardness at slightly better elasticity compared to use of acethydrazide. This is advantageous in use as a core ply in sandwich components such as automotive headlinings.

The open-cell content was measured with an AccuPyc 1330 gas displacement pycnometer.

| | Comparative | | | | | | | |
|---|---|---|---|---|---|---|---|---|
| | 90 | | Inventive | | Comparative | | Inventive | |
| | V2 | 90 V3 | 90 B | 90 C | 90 V4 | 90 V5 | 90 D | 90 E |
| average | 88% | 89% | 90% | 92% | 89% | 87% | 88% | 90% |
| value | | | | | | | | |

The inventive examples show somewhat higher open-cell content compared to use of acethydrazide. This is advantageous for use in sound-absorbing applications.

### Emissions According to Test Method 2 (Modified Bottle Method)

| | | Comparative | | Inventive | | Comparative | | Inventive | |
|---|---|---|---|---|---|---|---|---|---|
| | | 90 V2 | 90 V3 | 90 B | 90 C | 90 V4 | 90 V5 | 90 D | 90 E |
| Formaldehyde | mg/kg | 3.7 | 3.6 | 0.7 | 0.3 | 4.8 | 4.4 | 2.2 | 1.3 |
| Deviation | | −16% | −18% | −84% | −93% | | | −50% | −70% |
| compared to | | | | | | | | | |
| standard | | | | | | | | | |
| ΔFA/Additive | mmol/mol | −7 | −8 | −61 | −73 | | | −49 | −49 |

The results confirm the literature: Acethydrazide is in principle suitable for reducing the formaldehyde emissions from foams. However, cyanoacetylurea and other derivatives of cyanoacetic acid are significantly more effective.

In the experiments 90 D and 90 E the acetaldehyde emissions were reduced from 0.6 mg/kg (comparative 90V5) to 0.5 and 0.3 mg/kg respectively.

### Test Series 3: Semi-Rigid Slabstock Foam, for Example for Headlinings

(Delimitation from EP2138520)

### Description of Raw Materials

(A1/A2)-2: Polyether mixture of a glycerol/sorbitol-co-started polyalkylene oxide having an equivalent weight of 1.8 kg/mol and an OH number of 31 mg KOH/g, a glycerol-started polyalkylene oxide having an equivalent weight of 0.1 kg/mol an OH number of 560 mg KOH/g and a propylene glycol-started polyalkylene oxide having an equivalent weight of 0.2 kg/mol and an OH number of 280 mg KOH/g in a weight ratio of 39:49:12.
A2-2: Glycerol
A3-1: Water
A4-5: Silicone foam stabilizer
A4-6: Reaction product of oleic acid and dimethylaminopropylamine (1:1 molar)
A5-3: Cyanoacethydrazide
A5-7: Cyanoacetamide
B2-2: Mixture of MDI isomers and homologs having a density of 1.22 kg/liter, an isocyanate content of 322 g/kg and a viscosity of 0.05 Pa*s. The content of 4,4′-MDI is 47% by weight. The sum of 2,2′-MDI, 2,4′-MDI and 4,4′-MDI is 70%.

| | % by weight in polyol |
|---|---|
| | formulation |
| Polyether mixture (A1/A2)-2 | 82.75 |
| Silicone foam stabilizer A4-5 | 0.75 |
| Crosslinker A2-2 | 7.00 |
| Blowing agent A3-1 | 6.50 |
| Catalyst A4-6 | 3.00 |

Cyanoacetamide is known as a cell opener. It is accordingly not surprising that foams that contained cyanoacetamide were unstable and in one case collapsed. In the case of the foams 80 V2, 90 V6 and 100 V2 the blowing agent content was increased by 0.5 parts by weight and 1.5 parts by weight of Jeffcat DPA were added to obtain an approximately comparable apparent density.

### Usage Amounts of Additives A5:

In the comparative tests 80 V1, 90 V6, 110 V1 and 110 V1, no additive
was employed.

| | 80 V2 | 90 V7 | 110 V2 | 80 A | 90 F | 100 A | 110 A |
|---|---|---|---|---|---|---|---|
| | Cyanoacetamide | | | Cyanoacethydrazide | | | |
| Additive | (comparative) A5-7 | | | (inventive) A5-3 | | | |
| g/kg of | 8.3 | 7.7 | 7.2 | 8.0 | 7.4 | 6.9 | 6.5 |
| foam | | | | | | | |
| mmol/kg | 98 | 92 | 86 | 80 | 75 | 70 | 66 |
| of foam | | | | | | | |

### Kinetic Characterization of the Foams

| | | | | | |
|---|---|---|---|---|---|
| Cream time (seconds) | Index | 80 | 90 | 100 | 110 |
| | Designation | 80 V1 | 90 V6 | 100 V1 | 110 V1 |
| Additive None | Comparative | 35 | 27 | 25 | 43 |
| | Designation | 80 V2 | 90 V7 | 100 V2 | |
| Additive Cyanoacetamide | Comparative | 22 | 24 | 23 | |
| | Designation | 80 A | 90 F | 100 A | 110 A |
| Additive Cyanoacethydrazide | Invention | 22 | 25 | 25 | 28 |
| Fiber time (seconds) | Index | 80 | 90 | 100 | 110 |
| | Designation | 80 V1 | 90 V6 | 100 V1 | 110 V1 |
| Additive None | Comparative | 170 | 170 | 175 | 215 |
| | Designation | 80 V2 | | 100 V2 | |
| Additive Cyanoacetamide | Comparative | 290 | | 255 | |
| | Designation | 80 A | 90 F | 100 A | 110 A |
| Additive Cyanoacethydrazide | Invention | 180 | 200 | 210 | 225 |
| Rise time (seconds) | Index | 80 | 90 | 100 | 110 |
| | Designation | 80 V1 | 90 V6 | 100 V1 | 110 V1 |
| Additive None | Comparative | 225 | 267 | 285 | 277 |
| | Designation | 80 V2 | 90 V7 | 100 V2 | |
| Additive Cyanoacetamide | Comparative | 330 | 275 | 300 | |
| | Designation | 80 A | 90 F | 100 A | 110 A |
| Additive Cyanoacethydrazide | Invention | 246 | 250 | 255 | 305 |

The test comprising employing cyanoacethydrazide as an additive results in foam collapse at an index of 100. The test with an index of 110 was not performed.

### Mechanical Characterization of the Foams

| | | | | | |
|---|---|---|---|---|---|
| Core apparent density in kg/m³ | Index | 80 | 90 | 100 | 110 |
| Before ageing | Designation | 80 V1 | 90 V6 | 100 V1 | 110 V1 |
| Additive None | Comparative | 25 | 28 | 32 | 32 |
| | Designation | 80 V2 | 90 V7 | 100 V2 | |
| Additive Cyanoacetamide | Comparative | 31 | 31 | Collapses | |
| | Designation | 80 A | 90 F | 100 A | 110 A |
| Additive Cyanoacethydrazide | Invention | 26 | 30 | 30 | 29 |
| Core apparent density in kg/m³ | Index | 80 | 90 | 100 | 110 |
| After 7 days at 90° C. | Designation | 80 V1 | 90 V6 | 100 V1 | 110 V1 |
| Additive None | Comparative | 28 | 28 | 29 | 29 |
| | Designation | 80 V2 | 90 V7 | 100 V2 | |
| Additive Cyanoacetamide | Comparative | 28 | 30 | Collapses | |
| | Designation | 80 A | 90 F | 100 A | 110 A |
| Additive Cyanoacethydrazide | Invention | 25 | 28 | 28 | 31 |
| Compressive elastic modulus in | Index | 80 | 90 | 100 | 110 |
| MPa | | | | | |
| | Designation | 80 V1 | 90 V6 | 100 V1 | 110 V1 |
| Additive None | Comparative | 0.11 | 0.13 | 0.17 | 0.17 |
| | Designation | 80 V2 | 90 V7 | 100 V2 | |
| Additive Cyanoacetamide | Comparative | 0.14 | 0.14 | Collapses | |
| | Designation | 80 A | 90 F | 100 A | 110 A |
| Additive Cyanoacethydrazide | Invention | 0.10 | 0.14 | 0.15 | 0.14 |
| Compressive elastic modulus in | Index | 80 | 90 | 100 | 110 |
| MPa | | | | | |
| After 7 days at 90° C. | Designation | 80 V1 | 90 V6 | 100 V1 | 110 V1 |
| Additive None | Comparative | 0.14 | 0.13 | 0.16 | 0.15 |
| | Designation | 80 V2 | 90 V7 | 100 V2 | |
| Additive Cyanoacetamide | Comparative | 0.12 | 0.15 | Collapses | |
| | Designation | 80 A | 90 F | 100 A | 110 A |
| Additive Cyanoacethydrazide | Invention | 0.10 | 0.14 | 0.13 | 0.17 |
| Open-cell content in % | Index | 80 | 90 | 100 | 110 |
| Gas displacement pycnometer | Designation | 80 V1 | 90 V6 | 100 V1 | 110 V1 |
| AccuPyk 1330 | | | | | |
| Additive None | Comparative | 47 | 60 | 66 | 69 |
| | Designation | 80 V2 | 90 V7 | 100 V2 | |
| Additive Cyanoacetamide | Comparative | 81 | 88 | Collapses | |
| | Designation | 80 A | 90 F | 100 A | 110 A |
| Additive Cyanoacethydrazide | Invention | 60 | 52 | 47 | 43 |
| Glass transition temperature by | Index | 80 | 90 | 100 | 110 |
| DSC in ° C. | | | | | |
| | Designation | 80 V1 | 90 V6 | 100 V1 | 110 V1 |
| Additive None | Comparative | 244 | 204 | 202 | 229 |
| | Designation | 80 V2 | 90 V7 | 100 V2 | |
| Additive Cyanoacetamide | Comparative | 187 | 173 | Collapses | |
| | Designation | 80 A | 90 F | 100 A | 110 A |
| Additive Cyanoacethydrazide | Invention | | 240 | 247 | 228 |

### Formaldehyde Emissions (all Amounts in Mg/Kg of Foam)

| | | | | | |
|---|---|---|---|---|---|
| Before ageing | Index | 80 | 90 | 100 | 110 |
| Test method 1 | Designation | 80 V1 | 90 V6 | 100 V1 | 110 V1 |
| Additive None | Comparative | 1.5 | 1.1 | 0.9 | 1.2 |
| | Designation | 80 V2 | 90 V7 | 100 V2 | |
| Additive Cyanoacetamide | Comparative | 0.4 | 0.3 | Collapses | |
| | Designation | 80 A | 90 F | 100 A | 110 A |
| Additive Cyanoacethydrazide | Invention | 0.2 | 0.5 | 0.3 | 0.2 |
| After 7 days at 90° C. | Index | 80 | 90 | 100 | 110 |
| Test method 1 | Designation | 80 V1 | 90 V6 | 100 V1 | 110 V1 |
| Additive None | Comparative | 3.6 | 3.2 | 3.4 | 3.2 |
| | Designation | 80 V2 | 90 V7 | 100 V2 | 110 V3 |
| Additive Cyanoacetamide | Comparative | 1.6 | 2.5 | Collapses | |
| | Designation | 80 A | 90 F | 100 A | 110 A |
| Additive Cyanoacethydrazide | Invention | 0.9 | 0.9 | 1.3 | 1.2 |
| Before ageing | Index | 80 | 90 | 100 | 110 |
| Test method 2 | Designation | 80 V1 | 90 V6 | 100 V1 | 110 V1 |
| Additive None | Comparative | 4.5 | 6.1 | 6.2 | 6.7 |
| | Designation | 80 V2 | 90 V7 | 100 V2 | |
| Additive Cyanoacetamide | Comparative | 0.3 | 0.5 | Collapses | |
| | Designation | 80 A | 90 F | 100 A | 110 A |
| Additive Cyanoacethydrazide | Invention | 0.5 | 0.8 | 0.7 | 0.6 |
| After 7 days at 90° C. | Index | 80 | 90 | 100 | 110 |
| Test method 2 | Designation | 80 V1 | 90 V6 | 100 V1 | 110 V1 |
| Additive None | Comparative | 15.0 | 13.6 | 18.0 | 13.9 |
| | Designation | 80 V2 | 90 V7 | 100 V2 | |
| Additive Cyanoacetamide | Comparative | 3.2 | 3.9 | Collapses | |
| | Designation | 80 A | 90 F | 100 A | 110 A |
| Additive Cyanoacethydrazide | Invention | 3.0 | 3.0 | 3.0 | 4.3 |

### Formaldehyde Reduction (all Amounts in Mmol of Formaldehyde/Mol of Additive)

| | | | | | |
|---|---|---|---|---|---|
| Before ageing, test method 1 | Index | 80 | 90 | 100 | 110 |
| | Designation | 80 V2 | 90 V7 | 100 V2 | |
| Additive Cyanoacetamide | Comparative | 11 | 9 | Collapses | |
| | Designation | 80 A | 90 F | 100 A | 110 A |
| Additive Cyanoacethydrazide | Invention | 16 | 8 | 9 | 15 |
| After 7 days at 90° C. | Index | 80 | 90 | 100 | 110 |
| Test method 1 | Designation | 80 V2 | 90 V7 | 100 V2 | 110 V3 |
| Additive Cyanoacetamide | Comparative | 20 | 8 | Collapses | |
| | Designation | 80 A | 90 F | 100 A | 110 A |
| Additive Cyanoacethydrazide | Invention | 34 | 31 | 30 | 30 |
| Before ageing, test method 2 | Index | 80 | 90 | 100 | 110 |
| | Designation | 80 V2 | 90 V7 | 100 V2 | |
| Additive Cyanoacetamide | Comparative | 43 | 61 | Collapses | |
| | Designation | 80 A | 90 F | 100 A | 110 A |
| Additive Cyanoacethydrazide | Invention | 50 | 71 | 79 | 92 |
| After 7 days at 90° C. | Index | 80 | 90 | 100 | 110 |
| Test method 2 | Designation | 80 V2 | 90 V7 | 100 V2 | |
| Additive Cyanoacetamide | Comparative | 120 | 105 | Collapses | |
| | Designation | 80 A | 90 F | 100 A | 110 A |
| Additive Cyanoacethydrazide | Invention | 150 | 141 | 214 | 145 |

The results confirm the literature: Cyanoacetamide is suitable for reducing formaldehyde emissions.

It is apparent that cyanoacethydrazide is not only likewise well suited for reducing the formaldehyde emissions. This applies in particular after aging.

The use of cyanoacethydrazide also makes it possible to produce foams over a wider index range.

This is of great advantage for industrial use since foams are easier to adapt to customer requirements.

### Test Series 4: Flexible Molded Foam

(Delimitation from EP2138520).

### Description of Raw Materials

A1-2: Glycerol-started polyalkylene oxide having a molar weight of 6.1 kg/mol, an OH number of 28 mg KOH/g and a content of ethylene oxide of <50% by weight.
A2-3: Diethanolamine
A3-1: Water
A4-2: Tegostab® B8734 LF2 foam stabilizer, commercially available from Evonik Nutrition & Care, Essen
A4-3: Glycerol-started polyalkylene oxide having an OH number of 37 mg KOH/g and a content of ethylene oxide of ≥50% by weight (cell opener)
A4-7: Catalyst mixture of Jeffcat® ZR50 (commercially available from Huntsman) and Dabco® NE 300 (commercially available from Air Products) in a ratio of 4:1 (by weight)
A5-3: Cyanoacethydrazide
A5-7: Cyanoacetamide
B1-3: Mixture of MDI isomers and homologs having a density of 1.24 kg/liter, an isocyanate content of 325 g/kg and a viscosity of 0.03 Pa*s. The content of 4,4′-MDI is 60% by weight. The sum of 2,2′-MDI, 2,4′-MDI and 4,4′-MDI is 83% by weight.

| | Comparative | Comparative | Inventive | |
|---|---|---|---|---|
| | 90V8 | 90V9 | 90G | |
| Polyether A1-2 | 931 | 931 | 945 | g/kg |
| Cell opener A4-3 | 19 | 19 | 19 | g/kg |
| Crosslinker A2-3 | 11 | 11 | 11 | g/kg |
| Blowing agent A3-1 | 33 | 33 | 33 | g/kg |
| Catalyst A4-7 | 5 | 5 | 5 | g/kg |
| Cyanoacetamide A5-7 | 0 | 1 | 0 | g/kg |
| Cyanacethydrazide A5-3 | 0 | 0 | 1 | g/kg |

The two components A and B were brought to reaction with an index of 100.

The usage amounts of cyanoacetamide A5-7 and cyanoacethydrazide A5-3 are 7.1 and 6.0 mmol/kg of foam respectively.

The input materials recited in the examples are reacted with one another in the one-stage process in the manner of processing customary for the production of flexible moulded polyurethane foams in the cold-cure process. The reaction mixture at a temperature of 24° C. is introduced into a metal mold (volume 9.7 dm³) that has been heated to 60° C. and previously coated with a release agent (PURA E1429H NV (Chem-Trend)). The usage amount is employed according to the desired apparent density and mold volume. The moldings were demolded and wrung-out after 4 minutes. After 4 hours the moldings were sealed in aluminum composite film.

The formaldehyde emissions were determined according to method 2.

| | 90V8 | 90V9 | 90G | |
|---|---|---|---|---|
| | Compar- | Compar- | Inven- | |
| | ative | ative | tive | |
| Formaldehyde | 3.0 | 1.8 | 1.5 | mg/kg |
| Difference compared | Reference | 1.2 | 1.5 | mg/kg |
| to foam without additive | | | | |
| Specific reduction | Reference | 5.6 | 8.3 | mmol/mol |

The acetaldehyde emissions are 0.6 mg/kg without an additive. Both additives reduce the acetaldehyde emissions to below the limit of detection of 0.3 mg/kg.

It is apparent here too that cyanoacetamide is suitable for reducing emissions of formaldehyde.

Here too, cyanacethydrazide is even more effective.

1. A process for producing polyurethanes comprising reacting A) a compound containing isocyanate-reactive hydrogen atoms with B) di- and/or polyisocyanates in the presence of at least one compound comprising:
NC—CHR¹—CONR¹²—X (I),
NC—CHR²—CONR³-aryl (II),
NC—CHR⁴—CO₂H (III),
and
[NC—CHR⁵—CO₂]ₘY^{m+} (IV),
wherein
X represents NR⁶R⁷, OR⁸, CONR⁹R¹⁰ or COOR¹¹,
R¹ to R¹² each independently of one another represent H, an unsubstituted C₁-C₈ alkyl group, a substituted C₁-C₈ alkyl group, an unsubstituted aryl group, or a substituted aryl group,
Y represents a monovalent or divalent cation,
and
m represents 1 or 2,
or combinations thereof.

2. A process for producing polyurethanes which comprises reacting A) a component containing isocyanate reactive hydrogen atoms which comprises
A1 a compound containing isocyanate-reactive hydrogen atoms having an OH number according to DIN 53240 of ≥15 to <260 mg KOH/g,
A2 optionally, a compound containing isocyanate-reactive hydrogen atoms having an OH number according to DIN 53240 of ≥260 to <4000 mg KOH/g,
A3 water and/or a physical blowing agent,
A4 optionally auxiliary and additive substances selected from
a) catalysts,
b) surface-active additive substances,
and/or
c) pigments and/or flame retardants,
and
A5 one or more compounds comprising:
NC—CHR¹—CONR¹²—X (I),
NC—CHR²—CONR³-aryl (II),
NC—CHR⁴—CO₂H (III),
[NC—CHR⁵—CO₂]ₘY^{m+} (IV),
wherein
X represents NR⁶R⁷, OR⁸, CONR⁹R¹⁰ or COOR¹¹,
R¹ to R¹² each independently of one another represent H, an unsubstituted C₁-C₈ alkyl group, a substituted C₁-C₈ alkyl group, an unsubstituted aryl group, or a substituted aryl group,
Y represents a monovalent or divalent cation,
and
m represents 1 or 2,
or combinations thereof;
B) di- and/or polyisocyanates.

3. The process as claimed in claim 1, wherein
compounds (I) to (IV) are present in an amount of from 1 g to 100 g, based on 1 kg of the compounds containing isocyanate-reactive hydrogen atoms and the di- and/or polyisocyanates.

4. The process for producing polyurethanes as claimed in claim 2 wherein A) comprises
A1 75 to 99.0 parts by weight (based on the sum of the parts by weight of components A1 to A4) of a compound containing isocyanate-reactive hydrogen atoms having an OH number according to DIN 53240 of ≥15 to <260 mg KOH/g,
A2 0 to 10 parts by weight (based on the sum of the parts by weight of components A1 to A4) of a compound containing isocyanate-reactive hydrogen atoms having an OH number according to DIN 53240 of ≥260 to <4000 mg KOH/g,
A3 0.5 to 24.5 parts by weight (based on the sum of the parts by weight of components A1 to A4) of water and/or a physical blowing agent,
A4 0.5 to 10 parts by weight (based on the sum of the parts by weight of components A1 to A4) of auxiliary and additive substances selected from
a) catalysts,
b) surface-active additive substances,
and/or
c) pigments and/or flame retardants,
A5 1 to 100 g per kg of the components A1 and B, of one or more compounds comprising:
NC—CHR¹—CONR¹²—X (I),
NC—CHR²—CONR³-aryl (II),
NC—CHR⁴—CO₂H (III),
[NC—CHR⁵—CO₂]ₘY^{m+} (IV),
wherein
X represents NR⁶R⁷, OR⁸, CONR⁹R¹⁰ or COOR¹¹,
R¹ to R¹² each independently of one another represent H, an unsubstituted C₁-C₈ alkyl group, a substituted C₁-C₈ alkyl group, an unsubstituted aryl group, or a substituted aryl group,
Y represents a monovalent or divalent cation
and
m represents 1 or 2,
or combinations thereof
wherein all reported parts by weight for the components A1 to A4 are normalized such that the sum of the parts by weight of the components A1+A2+A3+A4 in the composition totals 100 parts by weight.

5. The process for producing polyurethanes as claimed in claim 2 which comprises reacting with one another
A1 25 to 45 parts by weight (based on the sum of the parts by weight of components A1 to A4) of a compound containing isocyanate-reactive hydrogen atoms having an OH number according to DIN 53240 of ≥15 to <260 mg KOH/g,
A2 20 to 74 parts by weight (based on the sum of the parts by weight of components A1 to A4) of a compound containing isocyanate-reactive hydrogen atoms having an OH number according to DIN 53240 of ≥260 to <4000 mg KOH/g,
A3 0.5 to 25 parts by weight (based on the sum of the parts by weight of components A1 to A4) of water and/or a physical blowing agent,
A4 0.5 to 10 parts by weight (based on the sum of the parts by weight of components A1 to A4) of auxiliary and additive substances selected from
a) catalysts,
b) surface-active additive substances,
and/or
c) pigments and/or flame retardants,
and
A5 1 to 100 g per kg of the components A1 and B, of one or more compounds comprising:
NC—CHR¹—CONR¹²—X (I),
NC—CHR²—CONR³-aryl (II),
NC—CHR⁴—CO₂H (III),
[NC—CHR⁵—CO₂]ₘY^{m+} (IV),
wherein
X represents NR⁶R⁷, OR⁸, CONR⁹R¹⁰ or COOR¹¹,
R¹ to R¹² each independently of one another represent H, an unsubstituted C₁-C₈ alkyl group, a substituted C₁-C₈ alkyl group, an unsubstituted aryl group, or a substituted aryl group,
Y represents a monovalent or divalent cation,
and
m represents 1 or 2,
wherein all reported parts by weight for the components A1 to A4 are normalized such that the sum of the parts by weight of the components A1+A2+A3+A4 in the composition totals 100 parts by weight.

6. A process for the production of polyurethanes, comprising reacting A) a component containing isocyanate reactive hydrogen atoms, with B) a di- and/or polyisocyanate, in the presence of one or more compounds comprising:
NC—CHR¹—CONR¹²—X (I),
NC—CHR²—CONR³-aryl (II),
NC—CHR⁴—CO₂H (III),
[NC—CHR⁵—CO₂]ₘY^{m+} (IV),
wherein
X represents NR⁶R⁷, OR⁸, CONR⁹R¹⁰ or COOR¹¹,
R¹ to R¹² each independently of one another represent H, an unsubstituted C₁-C₈ alkyl group, a substituted C₁-C₈ alkyl group, an unsubstituted aryl group, a substituted aryl group,
Y represents a monovalent or divalent cation,
and
m represents 1 or 2,
wherein the resultant polyurethanes exhibit reduced formaldehyde emissions.

7. The process as claimed in any of claim 6, wherein in the compounds (I) to (IV) R1 to R12 each independently of one another represent H or a C₁-C₆ alkyl group.

8. The process as claimed in claim 7, wherein R¹, R², R⁴ and R⁵ independently of one another represent H.

9. The process as claimed in claim 2, wherein component A1 comprises at least two hydroxyl-containing polyethers, optionally in admixture with at least two hydroxyl-containing polyesters.

10. The process as claimed in claim 9, wherein component A1 comprises at least 30% by weight of at least one polyoxyalkylene copolymer comprising a starter, propylene oxide and ethylene oxide and an end block made of ethylene oxide, wherein the total weight of the end blocks made of ethylene oxide is on average 3-20% by weight, based on the total weight of all polyoxyalkylene copolymers.

11. The process as claimed in claim 2, wherein component B comprises a diphenylmethane diisocyanate mixture comprising
a) 45% to 90% by weight of 4,4′-diphenylmethane diisocyanate,
b) 10% to 55% by weight of 2,2′-diphenylmethane diisocyanate and/or 2,4′-diphenylmethane diisocyanate,
and
c) 0% to 45% by weight of polyphenylpolymethylene polyisocyanate (“polycyclic MDI”) and/or 2,2′-, 2,4′-, 4,4′-diphenylmethane diisocyanate-based and/or pMDI-pMDI-based carbodiimides, uretdiones or uretdioneimines.

12. The process as claimed in claim 2, wherein component B comprises a diphenylmethane diisocyanate mixture comprising
a) 35% to 45% by weight of 4,4′-diphenylmethane diisocyanate,
b) 1% to 5% by weight of 2,2′-diphenylmethane diisocyanate and/or 2,4′-diphenylmethane diisocyanate,
and
c) 50% to 64% by weight of polyphenylpolymethylene polyisocyanate (“polycyclic MDI”) and/or 2,2′-, 2,4′-, 4,4′-diphenylmethane diisocyanate-based and/or pMDI-based carbodiimides, uretdiones or uretdioneimines.

13. A polyurethane/polyurethane foam obtainable by a process as claimed in claim 1.

14. The polyurethane/polyurethane foam as claimed in claim 13 having a density of 4 to 600 kg/m³.

15. An article comprising the polyurethane/polyurethane foam as claimed in claim 13 in furniture cushioning, textile inlays, bedding, automotive sponges, door trims, seat covers, or construction elements.

16. The process as claimed in claim 2, wherein compounds A5 is present in an amount of from 1 g to 100 g, based on 1 kg of the components A1) and B).
